(19) United States
(12) Patent Application Publication
(10) Pub. No.: US 2015/0123966 A1
(43) Pub. Date: May 7, 2015

(54) INTERACTIVE AUGMENTED VIRTUAL REALITY AND PERCEPTUAL COMPUTING PLATFORM

(71) Applicant: COMPEDIA - SOFTWARE AND HARDWARE DEVELOPMENT LIMITED, Ramat Gan (IL)

(72) Inventor: Shai Newman, Rosh Ha'ayin (IL)

(21) Appl. No.: 14/506,599

(22) Filed: Oct. 3, 2014

Related U.S. Application Data
(60) Provisional application No. 61/886,121, filed on Oct. 3, 2013.
(60) Provisional application No. 62/014,361, filed on Jun. 19, 2014.

(51) Int. Cl. G06T 19/00; G06F 3/00; G06F 3/01

(52) U.S. Cl. CPC G06T 19/006; G06F 3/011; G06F 3/012; G06F 3/005; G06T 2200/21
USPC 345/419; 345/633

(57) ABSTRACT

Disclosed are methods, devices and systems for providing an augmented and a virtual reality experiences. According to some embodiments, there may be provided a device comprising a digital camera assembly including an imaging sensor, one or more optical elements, and image data generation circuits adapted to convert image information acquired from a surrounding of said device into one or more digital image frames indicative of the acquired image information. A graphical display assembly including at least one display and driving circuits may be adapted to receive display instructions and to convert received display instructions into electrical signals which regulate illumination or appearance of one or more display elements. Processing circuitry, including image processing circuitry, may generate a set of display instructions for displaying a display image which is at least partially based on information within a digital image frame of the acquired image and one or more processing circuit rendered virtual objects, wherein selection of which virtual objects to render and how to position the virtual objects within the display image is at least partially based on a context state of said device.

### RELATED APPLICATIONS

The present U.S. Utility Patent Application claims priority from U.S. Provisional Applications: (1) No. 61/886,121, filed on Oct. 3, 2013; and (2) No. 62/014,361, filed on Jun. 19, 2014. Teaching complete disclosure of both these two provisional patent applications are hereby incorporated by reference in their entirety.

### FIELD OF THE INVENTION

The present invention relates generally to the field of augmented reality and virtual reality platforms. More specifically, the present invention relates to a personalized interactive Augmented Reality (“AR”), perceptual computing (“PerC”) and Virtual Reality (“VR”) platform/system.

### BACKGROUND

Recent advancements in small form factor computing power with low power consumption, integrated with visual elements such as a camera and display, created a whole new market of mobile devices like Smart-phones, tablets, light laptops, wearable computing device such as “Google-glasses” and the like which enable augmenting a picture displayed on the device's screen.

### SUMMARY OF THE INVENTION

The present invention includes methods, circuits, devices, systems and associated computer executable code for facilitating and integrating Augmented Reality, Perceptual computing elements and Virtual Reality into new types of interactions. According to some embodiments, there may be provided a mobile or stationary computational device including:

(1) a scene imager such as a camera assembly and associated circuits or webcam, that may include 3D camera; (2) a display such as an LED or OLEO or LCD display and may include 3D enabling glasses; (3) processing circuitry such as a general purpose or dedicated processor; (4) operating memory such as random access memory; and (5) augmented reality module or application stored on the operating memory and executed by the processing circuitry such that a virtual object is digitally rendered and displayed on the display of the device responsive to: (a) detection of an acquired image feature, (b) detection of a device orientation, location and direction, (c) detection of a device and/or the head positions, (d) detection of a device movement, (e) a user input through the device, and (f) detection of a trigger signal generated at an external device.

According to further embodiments, the augmented reality module may be further adapted to render a virtual object responsive to a specific trigger and at least partially in accordance with a context state of the device. A context state of a device according to embodiments may be defined by or otherwise associated with object definition information (001), which ODI may associate or map, during a specific context state with which the ODI may be associated, specific virtual object rendering definitions and/or virtual object behaviors responsive to specific triggers during the specific context state. For a given trigger during a given context state, the ODI may define trigger to virtual object characteristics such as displayed appearance, head position related to the device, displayed orientation relative to imaged objects, displayed orientation relative to device, and displayed orientation relative to a device position within space. Device context state definitions, such as those which may be provided by an ODI, may be locally stored on the device or may be generated and/or stored remotely and provided to the device via a data link. The ODI may be intended to convey context sensitive content and information.

According to further embodiments, a mobile computational device may also include a gyroscope and/or a compass and/or accelerometers which may serve the augmented reality module determine the device's 3-D orientation, and/or its distance and/or its position relative to a physical object in order to render and augment a virtual object either as overlay on the camera feed (“AR mode”) or as part of a virtual environment that may correspond to the camera feed image (“VR mode”).

According to some embodiments, the present invention may be used for education and/or corporate training, museum experiences and also corporate productivity tools. The invention may support universal context sensitive tracker(s), for example, by using generic trackers to trigger context sensitive layers, also referred to as context states, and/or data, such as e-book pages and slide related items, on the device. Context layers or states may be activated by any other input triggers such as touch, orientating the device to a specific direction (e.g. looking down and then showing on a surface a related AR or VR object such as, for example, a pendulum). This type of context triggering may be activated by any sensors (e.g. image, sound, proximity, orientation, etc.).

According to some embodiments, one or more of the device sensors may track a position and/or orientation of the device. In the embodiments where the device is a smartphone or tablet, the head tracking sensors may be a camera facing a user. Optionally, a generated display image of an object, whether a composite AR image or a VR image, may be altered based upon a sensed position and/or orientation of a user's/viewer's head. Coordination between the head position tracker and the image processing circuits may work such that movement of the viewer's head changes the display image's point of view of the displayed object on the screen. This feature may be useful for fixed objects like screens or projected slides, and may provide and/or enhance a 30 experience of the viewer.

According to some embodiments, the present invention may project AR elements or objects into VR space. The is images of composite objects, including both actual and virtual image components, may be projected in the a VR space or environment. According to some embodiments, an image acquired by a digital camera assembly, also referred to as a camera feed, may first be augmented with AR elements, and thereafter the device may switch into VR more by creating a virtual environment matching at least partially the original camera feed image elements, such as background and forefront objects. For example, if a user is watching a physical through the device when the, camera feed may be (gradually) replaced with a virtual environment in which the object(s), in this case the pages, may be replaced with virtual equivalents in (substantially) the same orientation and distance as in the imaged real world objects. This may provide a sense of continuity and smoothness during switching into a VR mode. This transitioning technique have benefits such as releasing the user for continuing to point the camera assembly at a specific object. It may provide for a better quality image with lesser sensitivity to lighting conditions or camera quality. According to this embodiment, the AR mode may be used for initial identification and orientation of the device and virtual objects relative to: (1) a real world (actual) objects with are background, (2) trackers, and/or (3) triggers for the device to enter into a specific context state. Afterwards releasing the user from having to continuously point and track a specific object or point in space may increase ease of use of the device.

According to some embodiments, the device may perform gradual alteration of an acquired image, for example the device may first freeze the camera feed, then put the virtual object in the same orientation on top of the image of its physical element on this camera feed (e.g. put the virtual page on top of the page image in the camera feed) and then optionally the device may create the background virtual object in a similar texture of the background of the physical background in the camera feed (e.g. if the physical page is on a desk then the virtual page will have similar texture and coloring as this of the physical one).

According to some embodiments, the device may enhance viewing quality of imaged physical objects by replacing or overlaying on top of the image a rendered equivalent virtual of the physical object. This may be done when the device either stores or has network access to a virtual representation of an object it has identified in the camera feed. The virtual object's orientation and positioning may be adjusted by image processing circuits of the device to make the overly or replacement. One example of physical object enhancement or replacement relates to the image capturing of worksheets. As an image of a real form or worksheet is acquire, the image may be “normalize”, for example to a top view at a defined distance from the page. According to some embodiments, this may provide a way to scan images either by tablets or standard webcams. By looking at a page through a mobile device camera or showing the page to a webcam, the page can be scanned, identifier, compared to a template associated with the form, checked, and manipulate. Comparing an identifier form or worksheet page against a known template, may be used to enhance ORC speed and accuracy for data entered into the fields of the form or worksheet. For example, in case of scanning a form, the device can first find the form orientation and distance, create a “normalized” version of it with top view and required size and then extract from it the variable elements or fields (e.g. that hand written filled areas in the form) and put (or “transplant”) it in the right location in the original higher quality equivalent pre scanned form). Additionally, when capturing (“scanning”) a known form, page or object, the device may replace the image of the form with its higher quality equivalent, optionally excluding the fields, variable or written areas. Upon performing OCR on the image information found in the known filed areas of the form, the device can store in a database only the fields and their location and overlaying the fields data on hi res version on the form as needed.

According to further embodiments, the device may include a three dimensional camera assemble, for example a camera assembly with two imaging apertures, spaced some distance apart, and a disparity map generator for estimating a depth for a given point of an object within an acquired image based on disparity of the given point's location between each of the images acquired through each of the two apertures. Additionally, the 3D camera may be of a structures light type or of a gated array type camera adapted to measure or estimate depth of points on acquired images. Such 3D cameras may be used according to any of the embodiments presented herein, including those relating to form and worksheet scanning. According to those embodiments, depth information associated with each point of a scanned form, worksheet or documents may be used to normalize orientation and/or sizing of some or all of a scanned item.

According to some embodiments, image processing circuits and algorithms of the device may detect, recognize and use text in the camera feed to identify and estimate spatial orientation of objects, including pages, in the camera feed. In some cases where there may be limited image quality surround a specific object, identification based on shape or texture features may be impossible, and only text found on the object (e.g. object contain text page, slide, poster, etc.) the device was trained to recognize may be used to identify the object and its orientation. Such an algorithm may include the following steps:

Page detection by OCR: the algorithm may use the distribution of the words in the page to find a matching record in a database. For the OCR process, the algorithm may use initially the objects (e.g. book pages) dictionary (i.e. the words the OCR try to match with) and then those dictionaries of the pages with the highest matching probabilities to further enhance matching.

Orientation and distance estimation: Once enough words of a page are identified to identify the template of the page, the words appearance on the imaged page may be compared to locations and orientation of corresponding words of the template to identify estimate the positions and orientation of the imaged/scanned page.

A variant of this method may not require identification of the actual words, but may identify the places where there are written characters. The algorithm may a patterns, much like a “bar code”, to both identify the page and then find its orientation in space.

According to some embodiments, the device may be in the form of 3D glasses which may generate two corresponding and complimenting image frames (left and right eye views) to provide a viewed with a 3D image frame. The 3D image frame may generated either in VR more, in AR and/or in combination of the two. According to embodiments where the device is operated in either AR or VR mode, regardless of whether the device is in the form of glasses, a phone or a tablet, image processing circuits of the device may perform visual analysis of a camera feed, for example from a forward looking camera. Image processing circuit identification of features, such as walls, trackers, markers, etc. in the device's surrounding may enable a user to move around with the device, for example, while looking at the device display. Feature identification of objects in the camera feed may allow the device to: (1) render virtual objects in the context of the device's position and orientation within its physical environment; (2) render virtual objects in the context of the device's position and orientation within a virtual space whose coordinate set is tied to, or otherwise linked or associated with, the device's physical environment; (3) identify risks, such as walls, stairs, etc. the user may be walking towards. This feature may enable free movement in a room and around hazards, wherein the device may notify or provide other indications to the user as to how close the user is to a wall, obstacle or drop. According to some embodiments, when the device gets close to a hazard, the camera feed initially used for location detection can be presented on the screen. Alternatively, a virtual room objected may be rendered on the display screen or screens, as in the case of 30 glasses, to indicate a location of a hazard detected by the image processing circuits. According to this embodiments, multiple people utilizing their respective device in a VR mode may move around within a common space, and virtual representations of each person may be rendered and presented to others.

According to some embodiments, the present invention may be used to direct a user to specific location within a given space. Image processing circuits of the device, operating within a given context state may identify a specific anchor tracker within a space whose dimensions have been mapped and whose contents are at known locations. Either in AR or in VR mode, the device may provide navigations within the space, for example the device see through the camera feed a specific anchor/tracker whose location within the space is known, and the device generate a virtual indicator as to the direction they need to move in order to reach a location of an objects or points of interest. The object to which directions are provided may or may not be associated with identified anchor/tracker. According to one example, the device may provide each of a group of people within a venue or shared space directions to their designated locations within the space, such as the location of a respective user's study or work group. The navigation indicators may be rendered in the form of arrows on the screen, arrows rendered as overlays on a wall, arrows or line overlays on the floor, or in any other form.

According to further embodiments, a first device may enable a first user to indicate an object or point of interest, within a common space, to a device of a second user with the common space, and since both devices may be synchronized to a common coordinate set, the second device may generate and present to the second user navigation instructions to the designated object or point of interest. According to yet further embodiments, a first user may use their device to define a virtual object and to place the virtual at some virtual coordinates within a virtual space whose virtual coordinates are tied to the physical coordinate of a shared or common physical space. The second device may, operating either in AR or VR mode, may render and show the virtual object when the second device is at or near the virtual coordinates at which the virtual object was placed.

According to embodiments of the present invention, image processing circuits of a device may estimate a distance to one or more points on an object or objects within a camera feed. The device may use focus parameters or signals generated by the camera assembly to estimate a distance to one or more objects at different points of acquired image. Using automatic software initiated actions, similar to “taping” on the screen using standard camera app, the device may detect surface distances and orientations related to objects on the camera feed. The device may estate object distances by correlating the time it takes for the camera to switch from a focused state onto a given object to a predefined camera focus state, such as MICRO or INFINITE. By timing a transition time from a known camera assembly state to a focus locked state, onto an object of interest, the device may estimate the location of the lens at time of focus lock on the object of interest, and in turn may estimate a distance to a surface point on the object of interest.

According to yet further embodiments, the device may overcome poor lighting conditions in order to enhance visual analysis capabilities by the image processing circuits. Overcoming may include enhancing lighting, for example by activating the led flash of a rear device camera. Additionally, when a user facing camera (like in the case of using WEBCAM on PC) is being used, the device may use the display for lighting, for example, the device may cause the screen to activate may bright pixels (example make it almost full white screen). This may allow the screen to be used as a “flash” for the duration of acquiring an image by the user facing camera. Additionally, different color pixels can be illuminated at different point in time during the image acquisition in order to enhance acquired image quality.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 20 shows an augmented reality example of a virtual object (in this example a virtual book) rendered on top of a table image captured by a mobile device's camera;

FIGS. 21a-21d shows examples of anchors initiating the rendering of an augmented reality object, wherein:

FIG. 21a and FIG. 21b shows examples of an anchor initiating the rendering of a corresponding virtual reality environment and objects;

FIG. 21c shows an example of using 3D glasses and rendering of virtual objects in a way that will create the appropriate 3D effect based on the device orientation.

FIG. 21d shows and example of using tracking the head position of the user to change the point of view of a virtual objects according to the movement of the head and its orientation and distance related to the virtual objects.

FIG. 22 shows an example in which the distance and orientation of a mobile device relative to a surface is determined using the mobile device's camera's focus;

FIG. 23 shows an example of two mobile devices rendering an augmented reality object from two different angles;

FIG. 24 shows an example of rendering a personalized augmented reality image;

FIGS. 25a-25d show examples of extracting the mobile device location within a room using an anchor and use it to infer room boundaries to enable proper display of virtual objects;

FIGS. 26a-26b show examples of showing indoor navigation and spatial guidance based on anchors and/or optional indoor location/positioning system with integration of positioning sound based on device direction;

FIGS. 27a-27c show examples of doing collaborative interactions using an anchor (or other surface detection technique) and of using visual anchors to support a Virtual reality glasses.

FIGS. 28a-28b show examples of an augmented reality image rendered on a wall which its location and orientation is inferred from focus data in case of a 2D camera or depth map in case of a 3D camera;

FIGS. 29a-29f show examples of information transmitted from one mobile device to other mobile devices describing different views of an object;

FIG. 30 shows an example of transferring pointing information from one device displaying an object at one orientation to another device displaying the same object at a different orientation;

FIGS. 31a-31d show examples of transferring marking information from an object at one orientation displayed on one device, to a similar object at a different orientation displayed on another device, of using words identification (OCR) to identify a page according to its text and calculate its orientation and distance according to relations between known identified words, and of using visual analysis for identification of weather a character is written or not to create a “bar code like” pattern of the page that then being used to identify the page and calculating its orientation and distance from the camera.

FIG. 32 shows an example of comments stored in a file, embedded into an object, e.g. a book, captured by a mobile device's camera;

FIG. 33 shows an example of an anchor tracking arrangement; and

FIG. 34 shows an example of capturing and scanning of an object in real time and normalize it to the defined size and orientation (usually “top view”) even if not presented this way to the camera.

It will be appreciated that for simplicity and clarity of illustration, elements shown in the figures are just given as examples and have not necessarily been drawn to scale and do not intend to describe all embodiments or use cases.

For example, the dimensions of some of the elements may be exaggerated relative to other elements for clarity.

Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention.

However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including magnetic hard disks, solid state disks (SSD), floppy disks, optical disks, CO-ROMs, DVDs, BlueRay disks, magnetic-optical disks, read-only memories (ROMs), random access memories (RAMs) electrically programmable read-only memories (EPROMs), electrically erasable and programmable read only memories (EEPROMs), Flash memories, magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

There is a constant progress in education, training and computer vision techniques. In the past people used to learn using paper books, and teachers used to write on a blackboard using chalk. As time passed, the paper books were replaced with electronic books which besides saving paper, cost and weight, they provide features such as text search and hyperlinks. Later on, features such as interactive tests and interactive labs were added to the web sites, interactive programs and e-books making the user experience much more effective and enjoyable. Nowadays, people are using their mobile devices everywhere, therefore there is an opportunity of providing them a new learning, training and other experiences and utilities by turning the mobile device (and in some cases a stationary PC with a webcam) into personalized interactive Augmented Reality (“AR”), Virtual Reality (“VR”) and perceptual computing (“PerC”) platforms and tools.

A present invention may include a device comprising a digital camera assembly including an imaging sensor, one or more optical elements, and image data generation circuits adapted to convert image information acquired from a surrounding of said device into one or more digital image frames indicative of the acquired image information. The device may include one or more activity sensors to detect activity on or near said device. It may include a graphical display assembly including at least one display and driving circuits adapted to receive display instructions and to convert received display instructions into electrical signals which regulate illumination or appearance of one or more display elements. Processing circuitry, including image processing circuitry, may generate a set of display instructions for displaying a display image which display image is at least partially based on information with a digital image frame indicative of an acquired image and one or more processing circuit rendered virtual objects, wherein selection of which virtual objects to render and how to position the virtual objects within the display image is at least partially based on a context state of said device, such that a context state defines spatial associations between virtual objects and objects within the digital image frame, and wherein the context state of said device is set substantially automatically in response to conditions or activity detected through said activity sensors or through said imaging sensor.

A given context mode may be triggered upon detection of any one or combination of: (1) one or more given objects in a digital image frame, (2) one or more given motions or gestures made with said device, (3) actuation of one or more user inputs, (4) one or more given sounds or sequence of sounds, (5) one or more given external electrical signals generated by an external device, (6) proximity of said device to a specific location, and (7) one or more persons located in proximity to said device.

The processing circuitry may be adapted to operate in operational modes including: (a) a first operational mode in which virtual objects are overlayed on to digital image frames indicative of acquired image information; and (b) a second operational mode in which acquired image information is used to generate or affect virtual elements of a virtual environment. The transition from the first operational mode to the second operational mode may occur incrementally, such that an physical object appearing within acquired image frame is augmented with virtual markings within the generated display image and the physical object is also represented by a virtual representation within the generated display image.

Rendered virtual objects may be encoded in real time from two different point of views, one for each eye of a user, in correspondence to selected 3D glasses and to achieve a 3D effect.

One or more activity sensors may be sensor adapted to identify a position of a user's head, and the image processing circuits are further adapted to adjust the display image on the display in accordance with a location in space of the head.

A rendered virtual object may be a virtual equivalent or representation of an object detected in the digital image frame and the virtual object may either augments, overlay or replace the detected object within the display image. The object detected in the digital image frame is a fillable form including both form text and fillable fields. The display image may include both: (a) a virtual equivalent of the detected form, and (b) digital image frame portions indicative of image information acquired from fillable field areas of the detected form. The display image and elements contained therein may be normalized based on anchor visual elements on the detected form or visual analysis and identification of the page in the space that may use a 30 camera. Presence or absence of text in a fillable field of the detected form may be assessed. Optical character recognition may be performed on digital image frame portions indicative of image information acquired from fillable field areas of the detected form.

A position and/or orientation of a display image representing a point of view within an at least partially virtual environment is at least partially based on image information acquired by the image sensor of the surroundings. The device may be in the form-factor of headgear and the graphical display assembly may include two separate displays, one for each eye of a user.

At least one digital camera assembly may be a forward looking camera assembly which enables the device to: (1) identify its location and point of view within a space; and (2) to generate user indicators corresponding to their location relative to the space and objects within the space. At least one virtual object or element within the display picture may be generated responsive to an external signal indicating an object or position in space designated by a user of another device.

A signal from optical focusing circuits of the digital camera assembly may be used to estimate a distance to a point on an acquired image.

Results of an optical character recognition process may be used to identify an object and estimate its distance and orientation relative to the device.

Results of a visual analysis that identify where characters are written or absent from an object may be used to identify the object and to estimate a distance and orientation of that object relative to the device.

At least one virtual object or element within the display image may be generated to direct a user to a specific object or location in space.

The device may include lighting compensation circuits selected from: (1) circuits which drive an illuminator of said device; and (2) circuits which drive the display of said device.

The device may include stabilizers for visual tracking, wherein the stabilizers are in the form of filters functionally associated with one or more sensors selected from the group consisting of: (1) a accelerometer, and (2) a gyro.

The device's digital camera assembly may be a 3D camera assembly and the image processing circuitry may be adapted to use depth information from acquired image frames to normalize a display image of an object within the acquired image frame. The device may be adapted to image and display normalized images of forms or pages.

It should be noted that the present invention is not limited to mobile devices and learning, and certain embodiments and teachings of the present invention can be implemented also on non-mobile devices and for applications other than learning or training.

According to some embodiments of the present invention, there may be provided a computational device, for many cases preferably a mobile computational device which includes a camera, a display, processing circuitry, memory, augmented reality and/or virtual reality software module stored on the memory and executed by the processing circuitry. According to some embodiments of the present invention, a user may hold the mobile device such that the mobile device's camera may capture the image of the background behind the mobile device. According to some embodiments of the present invention, the augmented reality software module may display on the mobile device's screen the image which the camera captures, and render an image stored in the mobile device's memory layered on top of the image captured by the camera, in a way that the stored image may seem, to a user watching the mobile device's screen, to be physically located behind the mobile device. For example, the user may hold the mobile device and face it towards a table, the camera may capture a picture of the table or other physical object, the augmented reality software module may display the table on the mobile device's screen, and may render an image of a book (or any other virtual object) stored in the mobile device's memory or created in real-time on top of the table image captured by the camera. The user experience watching the table through the mobile device's screen, may be as if there is a book (or any other rendered virtual object) on the table.

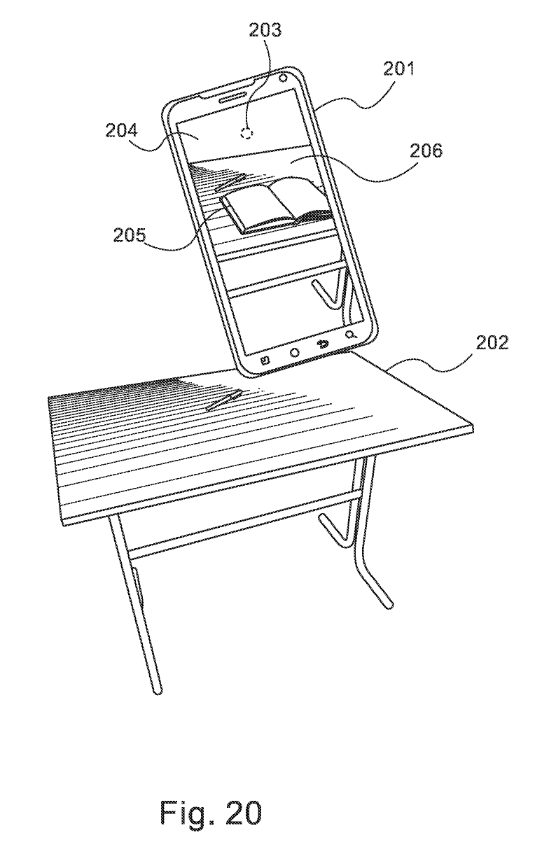

FIG. 20 shows an example of a mobile phone (201) facing a table (202), the mobile phone's camera (203) captures the image of the table and displays it on the mobile phone's screen (204), the augmented reality software module displays an overlay of a rendered virtual book (205) on or in front of the table (206). This example is a generic AR experience. The position and orientation of physical object, in this a table, is identified using several methods described below.

According to some embodiments of the present invention, the augmented reality software module may render the image stored in the mobile device's memory layered under the image captured by the camera. According to some embodiments of the present invention, the augmented reality software module may render the image stored in the mobile device's memory in any 30 position in relation to the object captured by the camera.

According to some embodiments of the present invention, the augmented reality software module may render the image stored in the mobile device's memory layered in front of several objects and behind other objects of the image captured by the camera and analyzed by the AR module.

According to some other embodiments of the present invention, the mobile device may have a button, either physical button or a virtual button on the screen. Upon the user pressing the button the augmented reality software module may freeze the image the camera captures so that the screen will keep displaying the last captured image. For example, the user may press the button in order to freeze the table's image so that when he/she wanders around with the mobile device, the book will still seem to be placed on the table even though the mobile device is not facing the table anymore.

According to some other embodiments of the present invention, the mobile device may store in its memory one or a first set of images of one or several physical elements (e.g. a page, poster or projected slide) which may analyzed and may serve as visual trackers or “anchors”. Alternatively, the mobile device may store in its memory a set of attributes of the one or several physical elements. In addition, the mobile device may store in its memory a second set of one or more images. The mobile device's camera may capture an anchor's image, and upon detection that the captured image is an anchor by comparing the captured image to the first set of stored images, or by comparing the captured image attributes (or as otherwise called “features”) to the stored set of attributes, or by any other detection technique known today or that may be devised in the future, by the augmented reality software module, it may initiate the rendering of an image from the second set stored in the mobile device's memory on the mobile device's screen. The above process can be implemented using specialized software libraries (e.g. Intel “real-sense” SDK) that enable train the system to recognize and then track in real time such visual trackers. For example, the mobile device may store the picture of a $1 bill (an anchor) and/or some attributes of a $1 bill image which may serve for its detection, when the $1 bill will be placed on the table and the mobile device will be pointed at it, the camera will capture the image of the $1 bill, the augmented reality software module will recognize the $1 bill as an anchor by comparing it to the $1 bill image stored in memory or by matching the attributes of the $1 bill captured image to the $1 bill attributes stored in memory, and upon identifying the bill and calculating in real time its location and orientation in space. The AR module can then initiate the display of a virtual book (or any other object) stored in the mobile device's memory, on the mobile device's display. According to some embodiments of the present invention, different anchors may initiate the display of the same image. According to some embodiments of the present invention, the same anchor may initiate the display of an image out of any number of objects, the object to be displayed may depend upon one or more causes such as context, position, orientation, time, location, etc. According to other embodiments of the present invention, different anchors may initiate the display of different images. For example, a $1 bill may initiate the display of a book, and a $20 bill may initiate the display of a virtual tool (e.g. virtual lab pendulum), guiding instruction on screen, visual analysis and checks etc. According to some embodiments of the present invention, the anchors may also serve as an orientation element. According to these embodiments the augmented reality software module may use the anchor's captured image size and orientation to determine the distance and orientation of the camera and mobile device relative to the anchor. According to some embodiments of the present invention, the augmented reality software module may render on the mobile device's screen an image stored in the mobile device's memory, with an image size and orientation which is derived from the anchor's distance and orientation relative to the mobile device. For example, if there is a $1 bill anchor on a table which may initiate the display of a virtual book or page on the mobile device's screen, the virtual book may be rendered on the screen as an overlay on the table in such a way that its size and orientation relative to the $1 bill will be as in real life. If the mobile device moves further from the table, the captured image of the $1 bill will be smaller and therefore the augmented reality software module may need to render a smaller image of the virtual book on the mobile device's screen in order to keep the real life proportion between the size of the bill and the book. If the mobile device moves aside, the angle from which the $1 bill image is captured changes, and therefore the angle in which the book is rendered may change accordingly giving the impression that the layered object, in this case a virtual book, is part of the physical world. According to some embodiments of the present invention, the user may interact and affect the virtual objects thru any input mean including touch, voice commands, head movement, gestures, keyboard or any other way, and the system may track these manipulations and user interaction and adjust the virtual object's position and/or orientation and/or size and/or any other attributes of the object, accordingly.

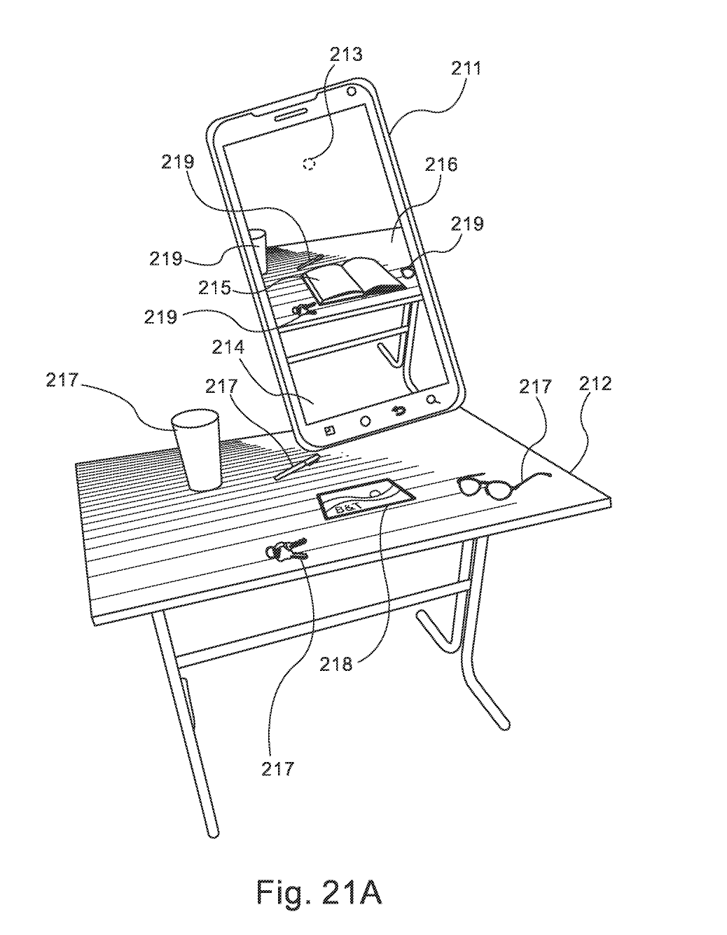

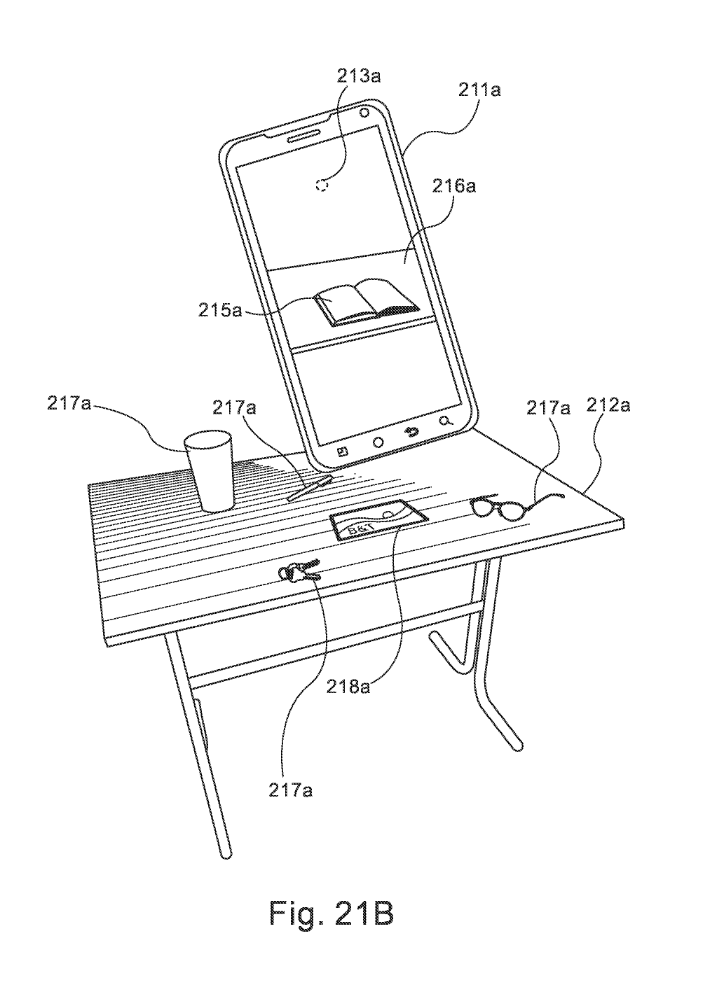

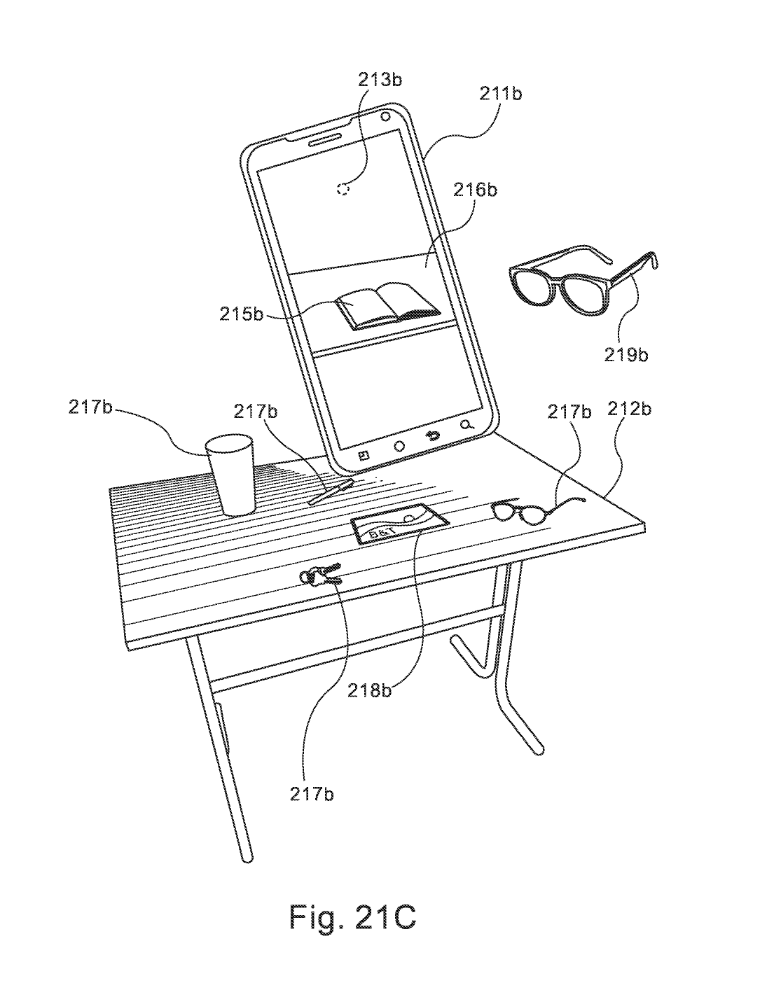

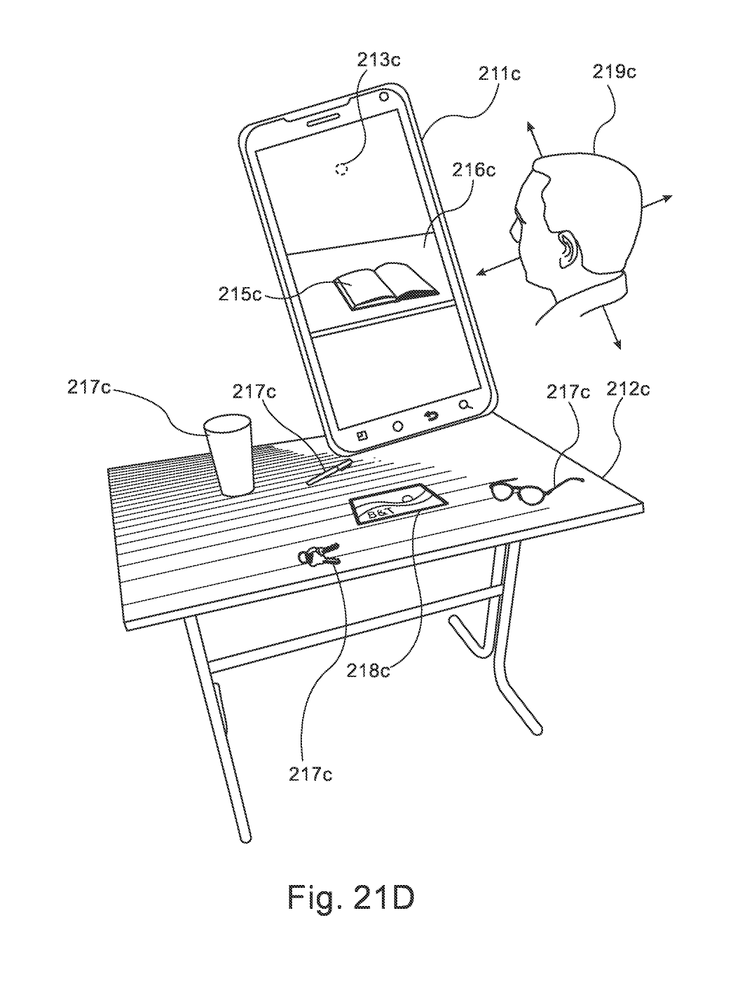

FIGS. 21a and 21b show examples of a mobile phone (211) facing a table (212) having several objects on it (217) and an anchor (218), the mobile phone's camera (213) captures the image of the table and the objects placed on it and the augmented reality software module detects the anchor (218) among the objects (217), and displays the table (216) with the objects (219) that are on the table on the mobile device's screen (214). The augmented reality software module also displays an overlay of a book (215) on the table (216) at the place the anchor was detected and at a relative size and orientation to the anchor.

FIGS. 21A and 21B show what happens when the system switch to Virtual Reality (VR) mode and how the continuation of the user experience is achieved. The camera feed from the device camera (213a) is stopped and the device generate a VR environment to the display of the device (211a) and a virtual surface (216a) is presented on the display at exactly the same orientation as of the physical surface (212a) at the time of the switching to VR, on which the anchor (218a) was placed on. The system may extract the visual features of the surface in order to make its VR representative more similar: for example it can extract its texture and other visual attributes in order to make the virtual objects similar to their physical equivalents. In the VR environment the virtual object, in this figure a book (215a) is presented, but the other physical objects (217a) are not. Once in VR the user may control the view and interaction using any input device as well as the device sensors (e.g. gyro to define the orientation) and perceptual computing elements (like head movement). As VR mode is not relying on the camera for the image generation, the user can interact with the objects without the need to point the camera to any specific point (e.g. the anchor) and can change the orientation for optimize view (e.g. laying on the back and request to “re-orient” and fit his current position).

According to some embodiments of the present invention, 3D glasses may be used for rendering 3D augmented reality and virtual reality images. FIG. 21c shows an example of using 3D glasses (219b) and rendering of virtual objects (216b, 215b) in a way that will create the appropriate 3D effect based on the device orientation and location. As long as the orientation and 3D position of the viewer is known to the system (both in VR and AR modes) the 3D view generator module can generate 2 images of all the virtual objects, one for each eye (usually 6.5 cm difference, for example: the first point of view is the 3D location and orientation of the virtual camera and the 2nd point of view for the other eye can be 6.5 cm away on a line that connect this first point and is parallel to the 3D line connecting the upper left and upper right 3D virtual positions of the device's display in the virtual space, assuming that the first view point is in the center of the device's display. In AR mode the first view point can be optimized to be in the approximate location of the camera vis a vi the screen, (213b)). Then this two views are decoded in accordance of the decoding method used by the selected 3D glasses (e.g. red-blue, anaglyph) so once the user view the generated image with the appropriate glasses the 3D effect is shown. According to embodiments, the encoding includes visual processing to minimize distortion generated by the encoding process.

FIG. 21d shows an example of using head (219c) location detection to affect the view shown on the device's display (211c). For example moving the head to the right will change the image on the display to reflect the point of view of the head when rendering the virtual objects on the display and can give the effect of looking thru a “window” into the virtual world. The head location can be inferred from the device virtual camera location in the virtual world and the head location related to the device. Both the device and the head can move at the same time. Different assumptions as per the properties of the “window” (that is shown on the device display) can create different effects. For the head location one can use SDKs and software libraries that usually use the front camera(s) of the device for this purpose (e.g. Intel real-sense SDK). This invention is especially useful when people are viewing fixed screen (e.g. PC or TV screen) or far away objects and can also be integrate with 3D glasses as described above to generate a new type of experience.

According to some embodiments of the present invention, an anchor stored in the mobile device's memory may include just part of the features of a physical element serving as the anchor. For example, a business card of a certain company can serve as an anchor. The augmented reality software module may detect the shape of the business card, the aspect ratio of the card, the company's logo on the card, and may ignore any text which may be different on business cards of that company such as the employee name, phone number, email, etc. In this way, any business card of a certain company may serve as an anchor regardless of the person owning it.

In some cases there may be a need to render on the mobile device's screen an image stored in the mobile device's memory as an overlay on a background which is captured by the mobile device's camera and also displayed on the mobile device's screen. This is enable high quality presentation that is not related to quality of the camera or the lighting conditions. For example, a user can view a page and view virtual objects in AR. The system can then replace the page, that is used as an anchor, with its virtual high quality version layered exactly at the same location as the physical page.

According to some embodiments of the present invention, the distance and orientation of the mobile device relative to a surface or object may be determined by using the mobile device's camera focus functionalities and determining several distances at several points between the mobile device's camera and the background.

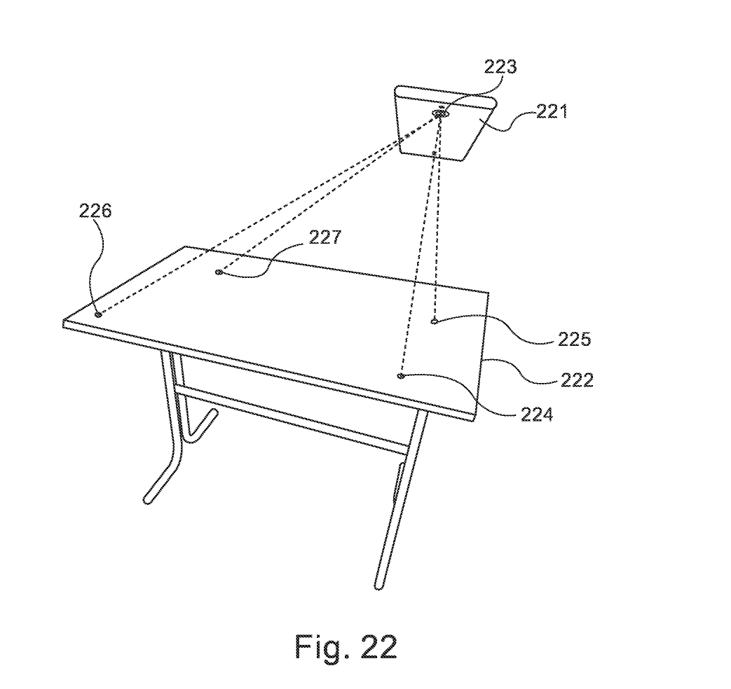

FIG. 22 shows an example of a mobile device (221) facing a table (222) from a certain distance and at an angle. The mobile device's camera (223) may be requested by the relevant functions of the AR module to focus on several points (224-227) on the table (using camera's “focus taping” functions of the device's operating system) to determine the distance of each of these points by inferring the time it takes to focus from a pre-define focus state(e.g. micro mode). From these points' distances the orientation and distance of the mobile device in relation to the table can be calculated. This process can enable “tracker-less” AR experience, especially when fused with other sensors like accelerometers, gyro and others that enhance the accuracy of the process.

If a 3D camera is available at the device, the “depth map” generated by the 3D camera can be used to identify the physical terrain and enable the AR module to render virtual objects accordingly.

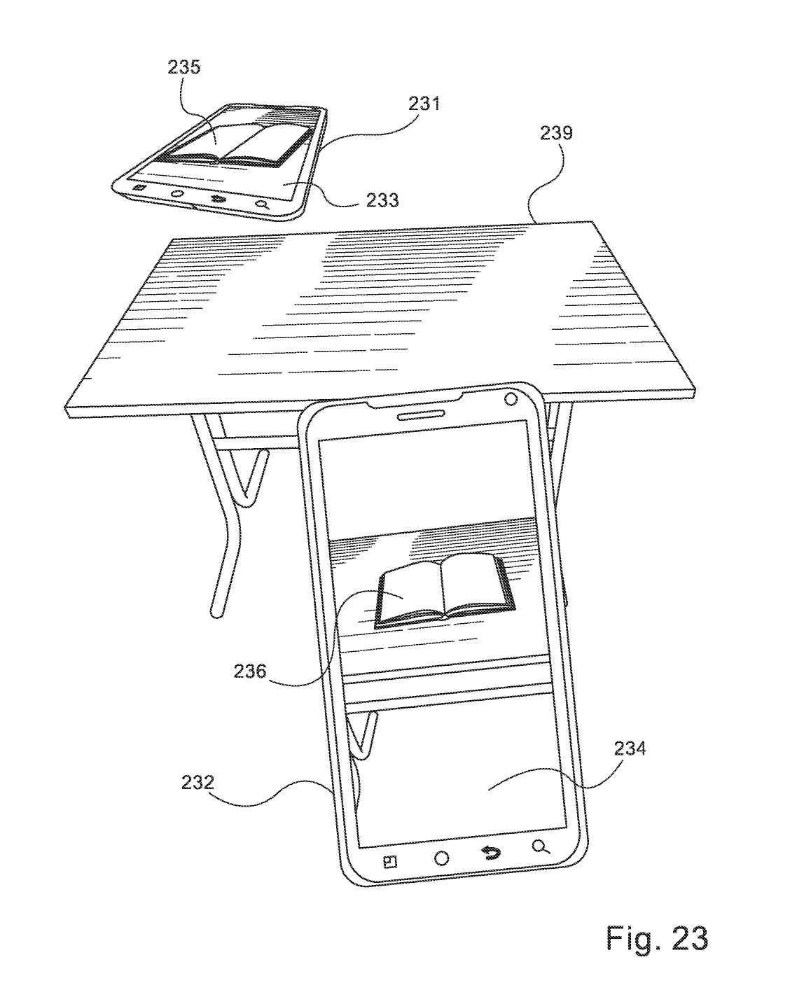

FIG. 23 shows two mobile devices (231 and 232) facing a table (239) from two different distances and at two different orientations. The two mobile devices retrieve the same image (or 3D model) of a book from memory and render it on the mobile devices' screen (233 and 234). Mobile device 231 which is closer to the table but faces it at a sharper angle, renders the image (235) larger and at a more trapezoidal shape on screen 233 than image 236 is rendered on screen 234 of mobile device 232. The experience can then be collaborative, for example if one user page the book and will be flipped also on the other's user's display.

According to some embodiments of the present invention, the distances points may be selected automatically, for example, by choosing the corners of the captured image. According to some other embodiments, the distances points may be selected manually by the user tapping on the screen on several points in the displayed background image. In most cases the AR module will initiate such “tapings” automatically (and in time intervals) in modes it is required to detect a surface. Again, as above, The distance of each “taping” may be inferred from the time it takes for the camera to reach micro (or infinite) camera focus states from a focused state (or the focused distance may be extracted from the operating system if available). The function that translates the time it takes to move from the current focused state to a micro (or alternatively infinite) camera state is positively correlated to the distance of the surface the camera is focused on, and it is unique and relatively stable to any device so it can be calculated in advance and enable substantially real-time translation of the above time to distance. Determining the surface location (distance and orientation relative to the camera) may be done by successive distance calculations in different points on the screen and then inferring the surface in front of the camera. According to some embodiments of the present invention, determining a surface distance and orientation from the camera (e.g. by using several focusing points) may enable placing virtual objects on top of a physical object (e.g. table) without the need for a visual anchor. According to some embodiments of the present invention, in addition to distances information gathered from the camera's focus, the precision of the distance and orientation of the captured surface relative to the mobile device may further be enhanced by data which may be fused by inputs from the sensors on the device like gyroscope and accelerometers as well as visual cues, if they exist.

According to some other embodiments of the present invention, the orientation of the mobile device relative to the background surface on which the stored image is to be overlaid may be determined by using the mobile device's camera and focusing on a location on the background surface, the focus may determine the distance to the point on the surface the camera is focused on, the relative distances to other points on the surface may also be determined from analyzing the amount of fuzziness of the image at these points The fuzzier the image is when the camera is set to infinite mode at that point, the closer it is from (to) the mobile device.

In some embodiments of the present invention there may be a need to present to the user on the mobile device's screen a personalized overlay, for instance: in a classroom there may be a “Daily Challenge” poster. The mobile device's camera may capture the poster's image, and upon determining that it is the “Daily Challenge” by the augmented reality software module, it can initiate the rendering of a personalized overlay image on the mobile device's screen. The overlay image may be personalized according to the user's identity, time, location, usage, etc. In some embodiments the rendered overlay may be personalized according to the user's profile such as age, gender, location, context, time etc.

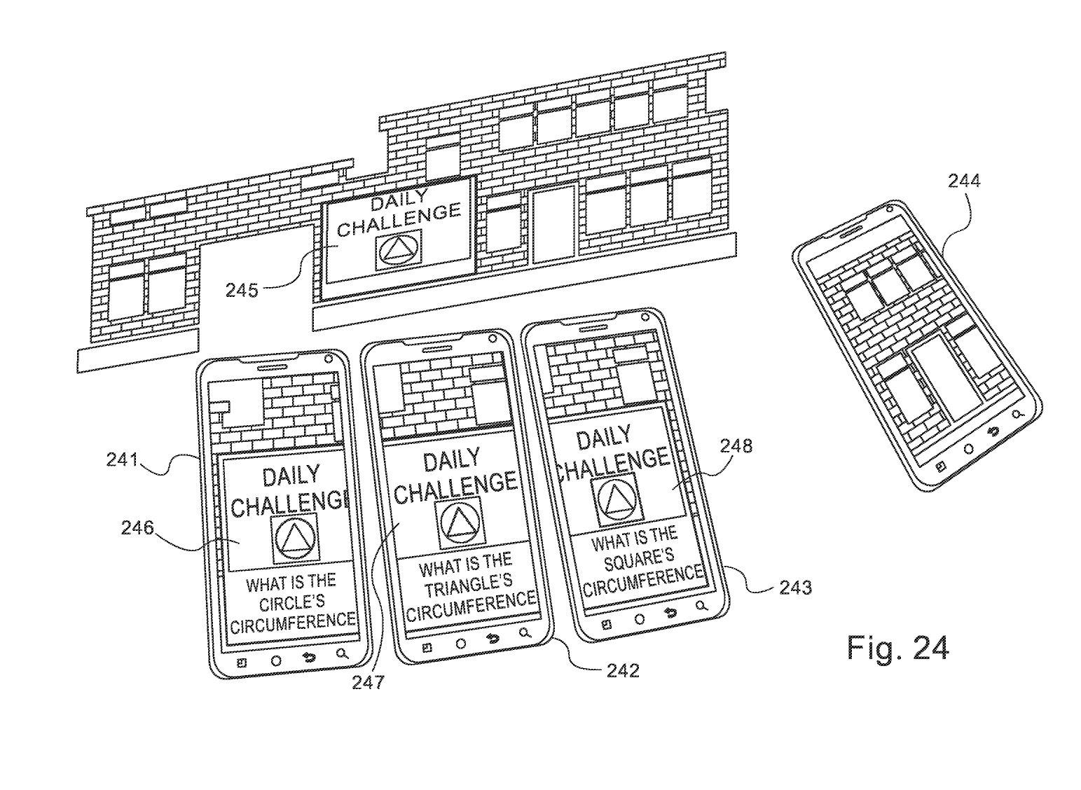

FIG. 24 shows an example of several mobile devices (241-243) facing a “Daily Challenge” poster (245), and another mobile device (244) which is not facing the poster. Mobile devices 241, 242, 243 display different daily challenges (246-248) which are personalized to their respective users overlaid on the poster, mobile device 244 displays the background captured by the mobile device's camera since it does not face the poster.

Another example is a classroom with the teacher presenting a slide showing an experiment, by pointing the mobile device to the slide, each child may see the slide with a different question regarding the experiment at the bottom of the slide or different missions.

According to some embodiments of the present invention, there may be stored in the mobile device's memory a first image, or identifying attributes of a first image, and a second stored image associated with the first stored image. Upon the augmented reality software module detecting that the image or part of the image captured by the mobile device's camera matches the first stored image, or upon detecting that the captured image attributes or the attributes of a portion of the captured image match the attributes of the first stored image, it may display the captured image on the screen and render on top of it the second stored image at a predefined location in the displayed first image. According to some other embodiments of the present invention, there may be stored in the mobile device's memory a first image, or identifying attributes of a first image, and a second stored 3D image associated with the first stored image. Upon the augmented reality software module detecting that the image or part of the image captured by the mobile device's camera matches the first stored image, or upon detecting that the captured image attributes or the attributes of a portion of the captured image match the attributes of the first stored image, it may display the captured image on the 30 glasses and render on top of it the second stored 3D image at a predefined location in the displayed first image.

In other embodiments of the present invention the personalized overlay may be used for collaborative activities such as gaming. For instance, several users may point their mobile devices towards the same slide in the classroom, in response to the detection of the captured slide by the augmented reality software module in each mobile device, it may render on the mobile device's screen a personalized overlay image. Therefore each user may see a different scene and play in collaboration with his peers. For example, in a Poker game all users will “sit” around the same table, but each user will see only his own cards which will be rendered personally for him on the mobile device's screen. In this embodiment the mobile devices may need to communicate with each other, either directly or through a server.

In some cases there may be a need to dynamically personalize the augmented reality image. According to some embodiments of the present invention, the mobile device may communicate with a second device (e.g. server), also when they are far away. The mobile device may send to the second device data regarding user input and point of view. The mobile device may also receive from the second device dynamic personalization data. According to these embodiments there may be stored in the mobile device's memory a first image, or identifying attributes of a first image, and optionally at least two second stored images associated with the first stored image. Upon the augmented reality software module detecting that the image or part of the image captured by the mobile device's camera matches the first stored image, or upon detecting that the captured image attributes or the attributes of a portion of the captured image match the attributes of the first stored image, it may display the captured image on the screen and render on top of it one of the second stored images as determined by the personalization data received from the second device, at a predefined location in the displayed first image or at a location determined by the personalization data received from the second device, or, it may render on top of the captured image data received from the second device at a predefined location or at a location determined by the data received from the second device.

According to some embodiments, when the augmented reality software module detects that the user shifted the mobile device away from pointing to the first image (e.g. poster or slide) or when the mobile device's gyro detects that the mobile device is facing down or at least at an angle which is below a predefined angle from horizontal or at an angle lower by a predefined amount from the angle at which the first image was detected, and/or when the mobile device's camera focus detects that the captured image is closer than the first image (e.g. poster or slide) by a predetermined distance or when the captured object is closer than a predefined distance, it may cease rendering the second image or personalized second image or dynamically personalized second image or anything received from the second device for displaying as an overlay on the first image (e.g. poster or slide), and start rendering a different image such as the background captured by the mobile device's camera, or any personal view (e.g. learning book) as an augmented reality or virtual reality view.

According to some embodiments of the present invention, the mobile device may store in its memory a first image or the attributes of a first image which may serve as an anchor, and at least one second image. The mobile device's camera may capture an object in the room such as a poster or slide. The augmented reality software module may detect the captured image as an anchor by comparing the captured image or the attributes of the captured image to the first stored image or to the attributes of the first stored image, and may render an overlaying second image on top of the anchor (e.g. poster or slide). If the user remains in the same place or if the user moves and the augmented reality software module can update its location by any kind of positioning system like GPS, INS or Beacon, and the user starts turning the mobile device around the room, the mobile device's gyro may detect the movement and device orientation and communicate it to the augmented reality software module, the augmented reality software module may then render an overlay second image according to the orientation in which the mobile device is in without the need for the visual anchor. For example, the rendered image may create the illusion that the user is in a museum (or a special room) and for each device orientation the mobile device is in, the augmented reality software module may render a different exhibit assuming, for example that the location of the user was not changed since last anchor was detected.

According to some embodiments of the present invention, the augmented reality software module may keep track of the mobile device's position and orientation using multiple inputs such as the camera capturing an anchor, the focus for distance estimation, gyro, accelerometer, compass for position and orientation detection, GPS and Beacon for position determination.

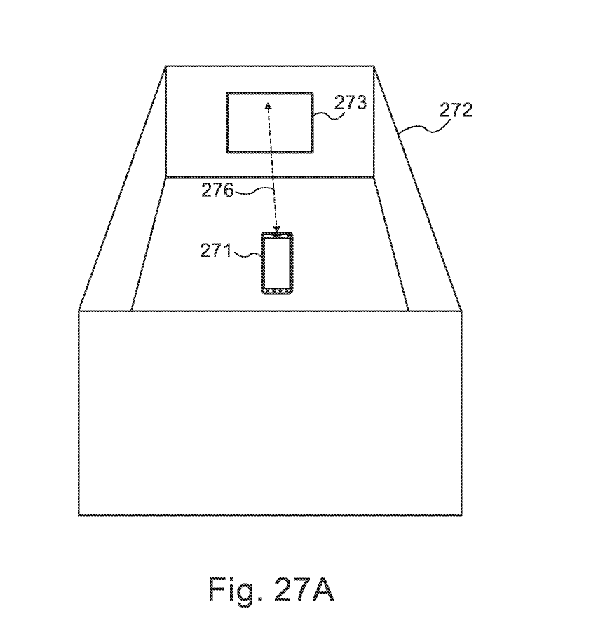

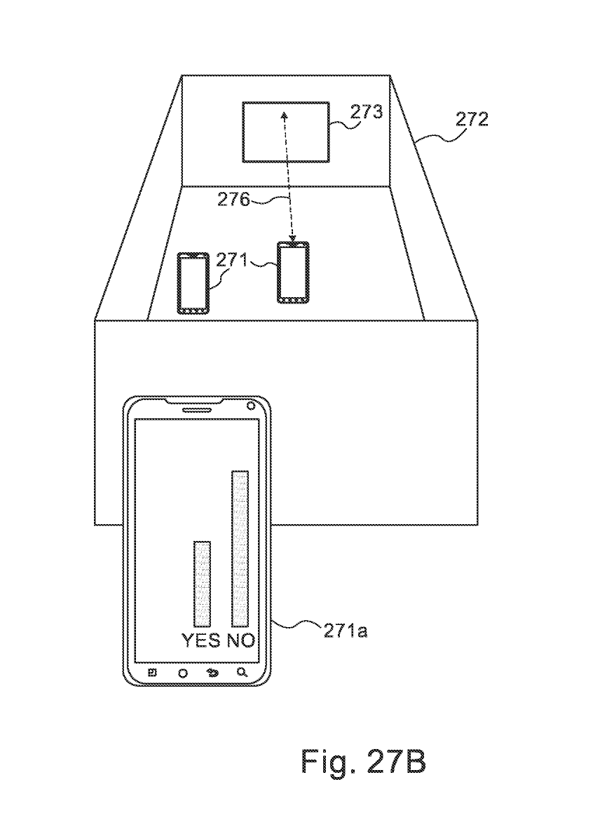

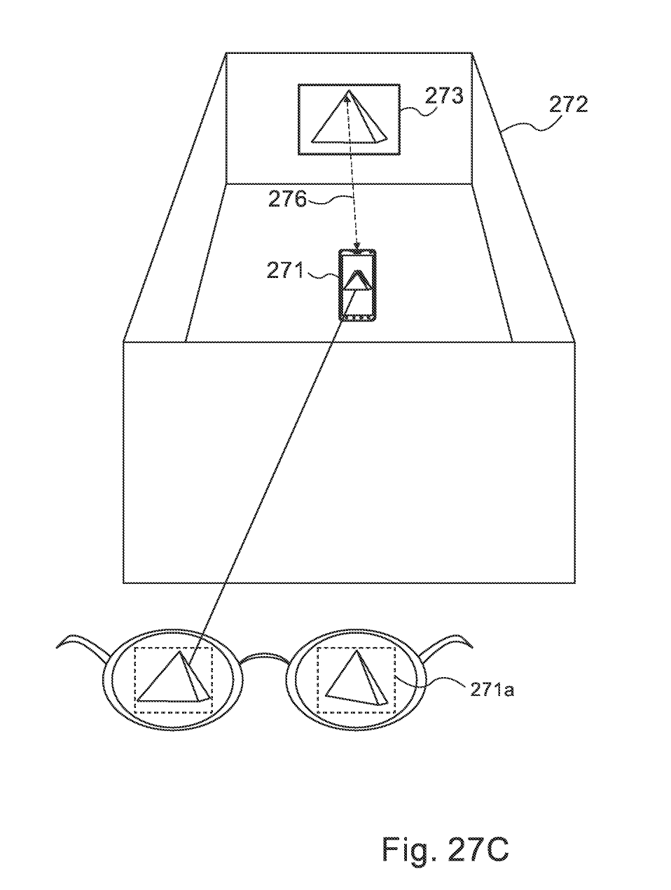

According to further embodiments, the user can wear 3D VR glasses (e.g. oculus riff) attached to the mobile device, on which Virtual Reality images may be displayed. The user can wander around while his location may be tracked by the augmented reality software module that will use either visual anchors/trackers or info form a 3D camera. The virtual reality displayed to the user may depend upon the location and orientation of the user. In some embodiments, a faded image of the room captured by the mobile device's camera or other indications may be displayed on the 3D glasses to prevent the user from hitting the walls or other objects. In other embodiments, the intensity of the faded room image may increase as the user gets closer to the wall. In yet other embodiments, the 3D glasses may be partially transparent so the user may see the walls when getting close to them. In other embodiments, the transparency of the 3D virtual glasses may increase as the user gets closer to the wall. FIGS. 27a-27c demonstrate this use case.

In some embodiments, when the augmented reality software module detects that the mobile device is facing the anchor back again, it may re-calibrate the location and orientation in order to compensate for any “drifts” and accumulated inaccuracies that may occur in the gyro while rotating the mobile device around.

According to some embodiments of the present invention, the room dimensions may be stored in the mobile device's memory, or from a remote device, along with the location within the room of an object which may serve as an anchor (e.g. poster or slide). The augmented reality software module may first identify the room based on its anchors and/or inputs from indoor and outdoor positioning systems (like GPS and Beacons) and extract the viewer location within the room from objects captured by the mobile device's camera. One location extraction method may be by using the camera, while the mobile device faces the anchor, the camera captures its image and the augmented reality software module extracts the location by calculating the distance from the anchor according to its known size, in case the room structure and locations of these anchors are known to the system the viewer location as well as the room boundaries can be calculated.

According to other embodiments of the present invention, in which there are several mobile devices which communicate among each other either directly or through a server, and in which the room dimensions are not stored in the mobile device's memory, the room structure may be determined by combining information gathered from several mobile devices. According to these embodiments, each mobile device may contribute to the creation of the room structure its location (based on GPS or Beacon) and orientation (based on visual anchor and/or gyro, compass, accelerometer), and the distance to room elements (e.g. walls), for instance by using the mobile device's focus properties or 3D camera.

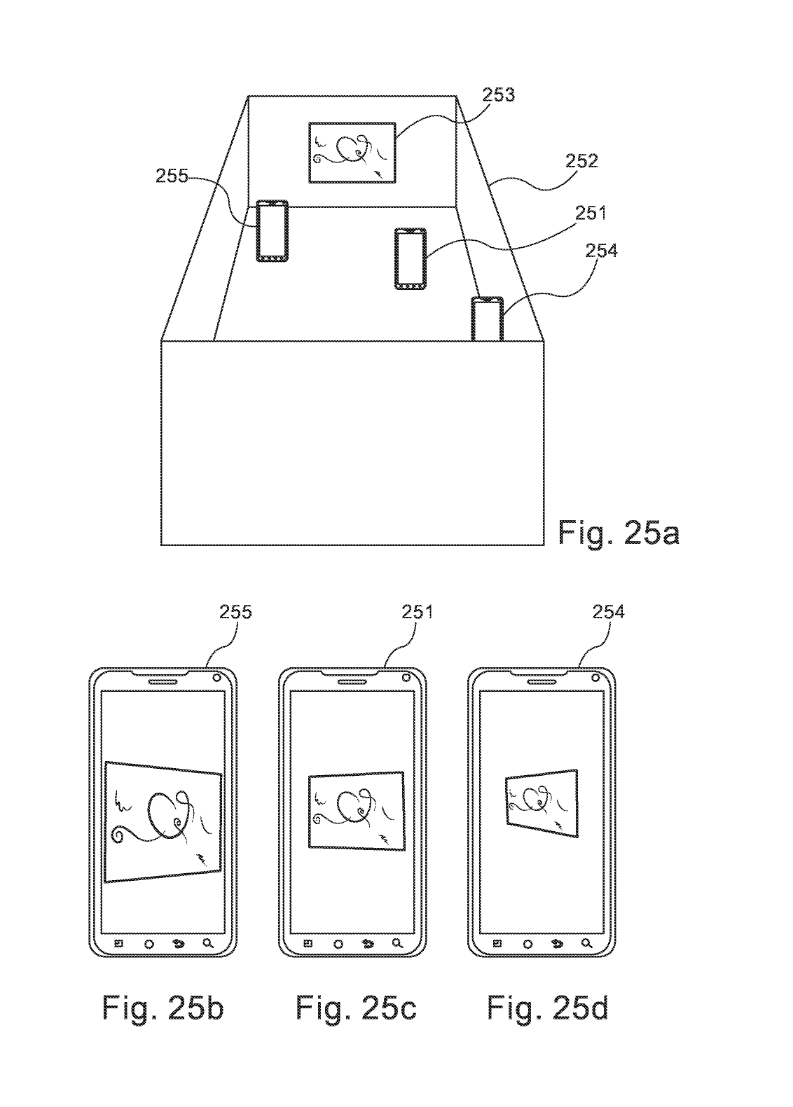

FIG. 25 shows an example of 3 mobile devices (251,254, 255) in a room (252) and a whiteboard (253) on the front wall of the room. FIG. 25b shows the whiteboard's image as captured by the mobile device's camera of device 255. FIGS. 25c and 25d show the same example for mobile devices 251 and 254 respectively, located in different places in the room. The locations of the devices can be shared and the system can infer some rooms minimal boundaries based on some assumptions (for example, assuming that all devices are on the same room and, for example, have direct line of sight between them) and project virtual objects in the space within these boundaries without pre-defined info on the room boundaries. Same can be done by mutual “scanning” of the room by the various devices.

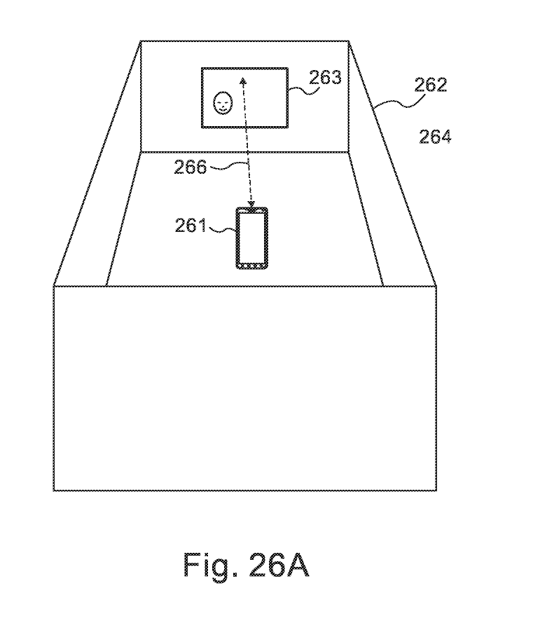

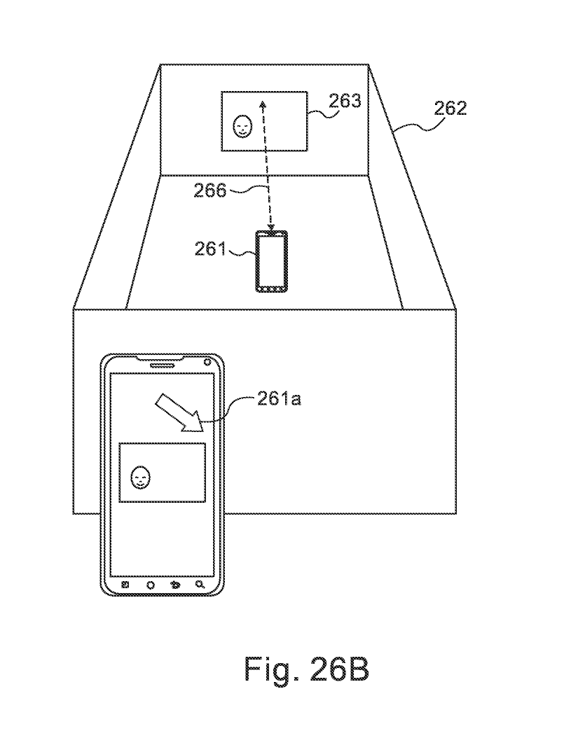

FIGS. 26a-26B show an example of a mobile device (261) in a room (262) and a visual encore, a whiteboard (263) on the front wall of the room. The augmented reality software module determines the mobile device's location and orientation according to the visual encore or other methods described herein and then show “navigation” or “attention” instructions, for example by showing an arrow toward the right direction or object.

This can be done in collaboration with indoor navigation system (e.g. beacon) fusing the location data with the accurate location and orientation of the visual encore to present highly accurate visual directions, like navigation in room or around the machine (that may include several encores) to identify the right direction to go or the right location to look at.

FIG. 27a-27c show an example of doing collaborative interactions using an anchor (or other surface detection technique). Two mobile devices (271) in a room (272) and one visual anchor, a projected slide (273) on the front wall of the room.

The augmented reality software module determines the mobile devices' location according to the encore or other methods described herein and then present a shared virtual object, in this case an interactive pole results in which the users participate.

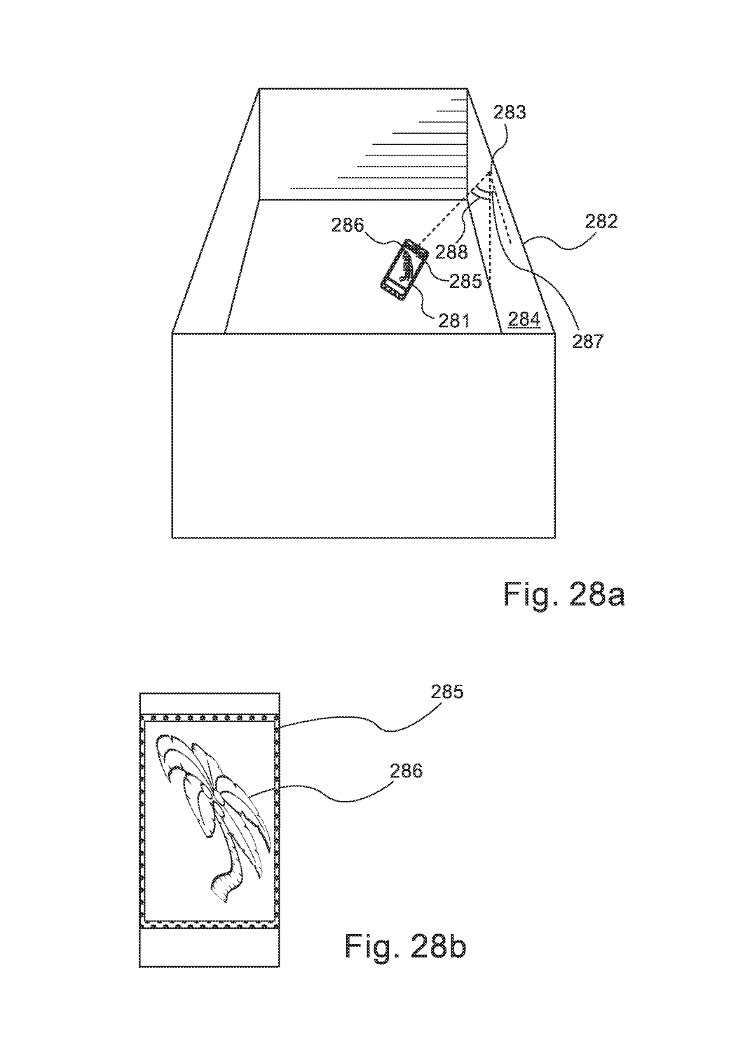

FIGS. 28a & 28b show an example of an augmented reality image rendered on a wall which its location and orientation is inferred from focus data in case of a 2D camera or depth map in case of a 3D camera. a mobile device (281) in a room (282), the mobile device is facing point 283 on the room's wall (284).

The mobile device's camera captures the wall's image and the augmented reality software module displays the captured wall image on the mobile device's display (285) and renders on top of it an image (286) retrieved from the mobile device's memory which corresponds to the angles (287,288) in which the mobile device faces. FIG. 28b shows image 286 as it is displayed on the mobile device's screen. Once the encore is not in the camera frame the other methods are used.

In some augmented reality applications the quality of printed text which is captured by the mobile device's camera and displayed on its screen should be enhanced in order to ease reading. For example, when a book which is captured by the mobile device's camera is read from the mobile device's screen, the quality of the text is badly effected by the camera quality and lighting conditions. According to some embodiments of the present invention, the page to be read is stored in high quality in the mobile device's memory (or extracted online), when the augmented reality software module detects that the camera is capturing that page, it may retrieve the page from memory, detect the orientation and distance of the captured page (given its is defined as encore or using other methods s described below), and render the page retrieved from memory (or extracted online) exactly in the location of the captured page, by doing so, the user may be able to read the page at high quality even when he is using his device camera in AR mode since the page displayed on the screen is the high quality page retrieved from memory (or extracted online) instead of the low quality page captured by the camera. The user may only notice that the displayed page is high quality, but might find it difficult to notice that the captured page was actually replaced by a different page since the page retrieved from memory (or extracted online) is rendered exactly or almost exactly on top of the page captured by the camera.

In some learning applications there may be a need for disseminating the screen's view of one mobile device (e.g. the teacher's device) to one or many other mobile devices (e.g. pupils). In these applications all mobile devices may have the same image of an object (2D or 3D) stored in memory and may view these objects together although each mobile device can look at the object from a different distance and/or orientation. A “3D ARIVR Pointing” (“3DP”) software module in the users' device (e.g. pupil's and teacher) may receive spatial coordinates and point of view information of a virtual camera as created by another user (e.g. teacher) and accordingly render the stored image on the mobile device's screen as it is seen from the virtual camera of the teacher or the one that present the object. In this way, the user (e.g. teacher) may show the other users (e.g. class) an object and explain about it. In this mirroring mode, when a user (e.g. the teacher) moves the object on his/her screen, or turns it, or zooms in/out, the same actions will show on the screens of the other mobile devices (e.g. of the children in the class). In pointing mode, the indications and pointing to specific locations will be shown while the students have their own point of view. In this manner very little data is transmitted to the mobile devices since no video is passed. An enhancement of this application is having the stored image constructed from several objects and information defining the spatial relationship between the objects, for example, an image of a basket and a ball may be constructed from two objects, 1-basket, 2-ball. There may be information regarding the location and orientation of the basket, and likewise there may be information regarding the location and orientation of the ball in the same coordinate system. The teacher may view the basket and the ball from a certain viewing point (for instance from behind the basket, or from the side), the viewing point information may be transmitted to the class mobile devices. The teacher can now move the ball relative to the basket without changing the viewing point, and the new ball coordinates will be transmitted to the class mobile devices. A further enhancement of this application is having at least one (virtual) light source lighting the object, the teacher can place the light source at a certain location and set some light attributes such as light intensity, lighting direction, lighting angle, light color, etc., the light(s) may create a shadow of the object which enriches the virtual reality experience. The light attributes may be transmitted to the class mobile devices. An even further enhancement of this application is adding attributes to the viewed object such as color, solid/frame view, texture etc. The teacher may change the object's attributes in order to better explain about the object and these attributes may be transmitted to the class mobile devices. In this way the teacher can look at an object displayed on his/her mobile device's screen, turn it around, zoom in or out, move it, or move or turn components of the object, light the object from a certain angle, change the object's texture etc., and the class will see on their mobile devices a copy of the teacher's screen.

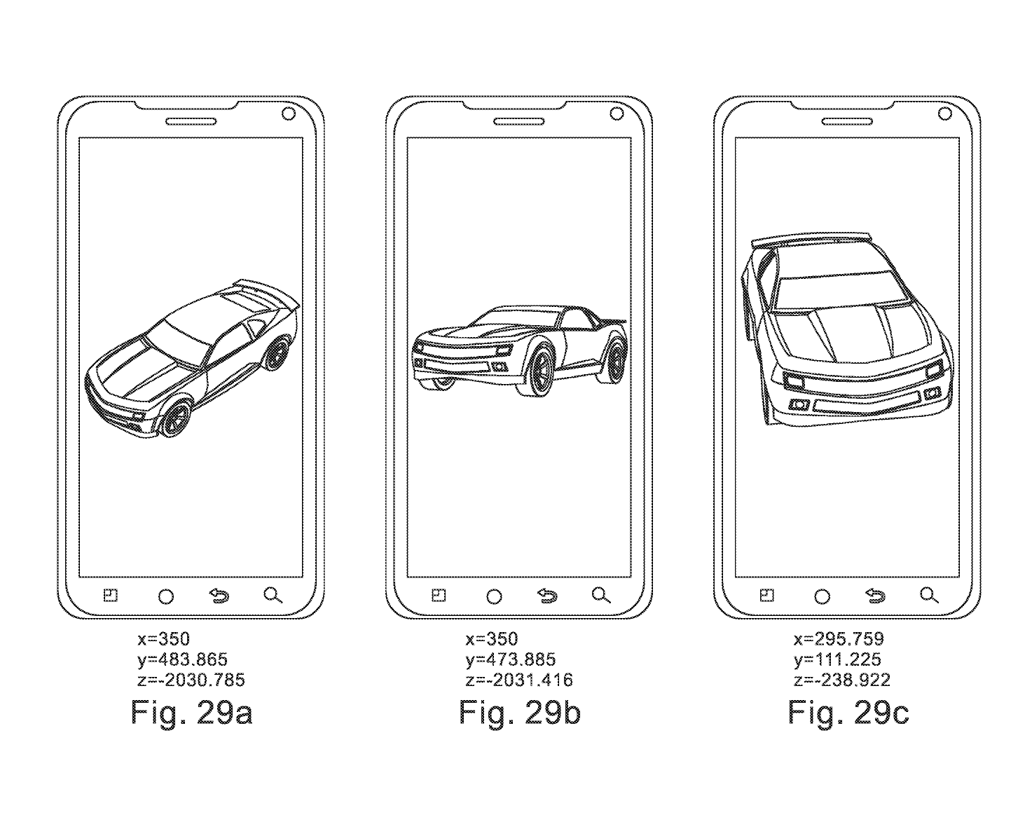

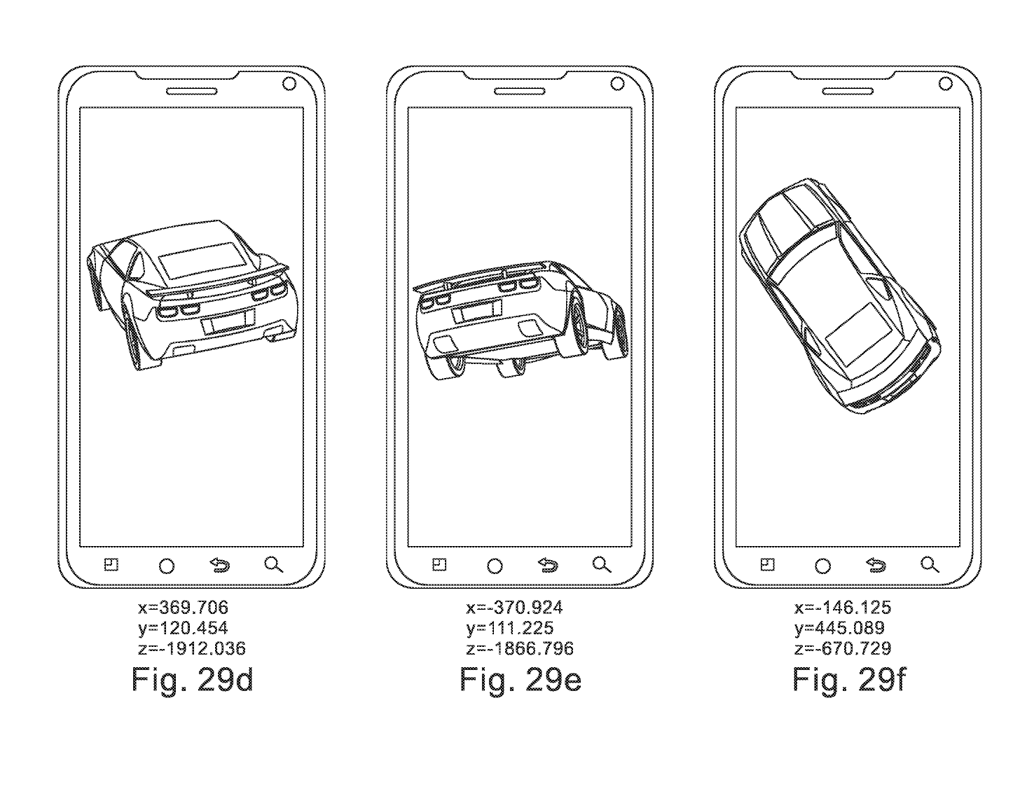

FIG. 29a shows a 3D object. FIGS. 29b-29f show the 3D object at several positions along with the information describing the position which is transmitted from the demonstrator's mobile device to the others' mobile devices.

According to some embodiments of the present invention, there may be provided a first and second computational device, preferably a mobile computational device which includes a display, processing circuitry, memory, virtual reality software module stored on the memory and executed by the processing circuitry. According to some embodiments the second computational device may be multiple devices. According to some embodiments of the present invention, there may be stored in the memory of the first and second device an image of a 2D or 3D object. According to some embodiments, the object may be constructed from one or more components, along with information defining the spatial relationship between the object's components. According to some embodiments, there may be some attributes associated with the object or the object's components, the attributes may include: color, texture, solid/frame appearance, transparency level, and more. According to some embodiments of the present invention, the object stored in memory of the first device may be rendered on its screen by the virtual reality software module and the user of the first device may have means for controlling the object's view such as turning the object to the right/left, turning the object up/down moving the object to the right/left, moving the object up/down, zooming in/out, pointing on specific locations, moving or turning object's components relative to each other, lighting the object from one or more angles, changing the light's intensity and/or color and/or span, changing the object's or its components' color and/or texture and/or solid/frame appearance and/or transparency level and/or any other attribute associated with the object or its components. According to some embodiments, the means for controlling the object's view may include a mouse, a keyboard, a touch-screen, hand gestures, vocal commands. According to some embodiments of the present invention, information of the first device's user commands or information of the view or the change in view of the object may be transmitted to the second device or devices. According to some embodiments of the present invention, the second device may receive from the first device information regarding the first device's user commands or information of the view or the change in view of the object, and may render an image of the object stored in the second device's memory on the second device's screen according to the view information received from the first device.

In some applications such as learning applications there may be a need for one person (e.g. teacher) to mark or point at or write on or draw on a certain location of an object in the image displayed on his/her mobile device's screen, and to disseminate that marking or pointing or writing or drawing to one or many other mobile devices (e.g. pupils). The pupils' mobile devices may display on their screen a virtual reality or augmented reality object identical to the object displayed on the teacher's screen but not necessarily at the same orientation since each child may individually control the object's orientation, or the pupils' mobile devices may display on their screen an object captured by the mobile device's camera similar to an object captured by the teacher's mobile device's camera. The marking or pointing or writing or drawing that the user (e.g. teacher) makes on the object displayed on his/her mobile device's screen may be reproduced on the other user (e.g. child's) mobile device screen at the same 3D point on the object regardless of the position of the object or the pupil's point of view For example, this can be effective when students read a page and one student wants to assist a subgroup or a specific student. As a result of the teacher's action of marking/pointing/writing/drawing, the teacher's mobile device may send the teacher's action along with the point on the object on which the action was performed to the pupils' mobile devices. The same may work the other way around, when the pupil wishes to show the teacher or the class some marking/pointing/writing/drawing on the object. Upon receiving the teacher's action, the pupil's mobile device may render the action at the point on the object received from the teacher's mobile device. For example, the teacher and the pupils have a virtual reality image of a chessboard displayed on their screens, the teacher and each of the pupils may view the chessboard from a different angle. The teacher may point at the white queen and all pupils will see the white queen pointed at, regardless of their viewing angle or distance. In another example the teacher and the pupils are each pointing their mobile devices' camera to a learning book which is then displayed on the mobile device's screen. Each of the teacher or children may view the book from a different angle or distance. The teacher may mark or circle on the book's image on the screen a word in the book, and the information of the teacher's action may be disseminated to the pupils' mobile devices. Each pupil's mobile device will then detect the teacher's marked word on its own displayed book and mark that word accordingly. Although this example is presented with reference to pupils and teachers, it should be clear that the exemplary embodiment may be applicable to any category of users.

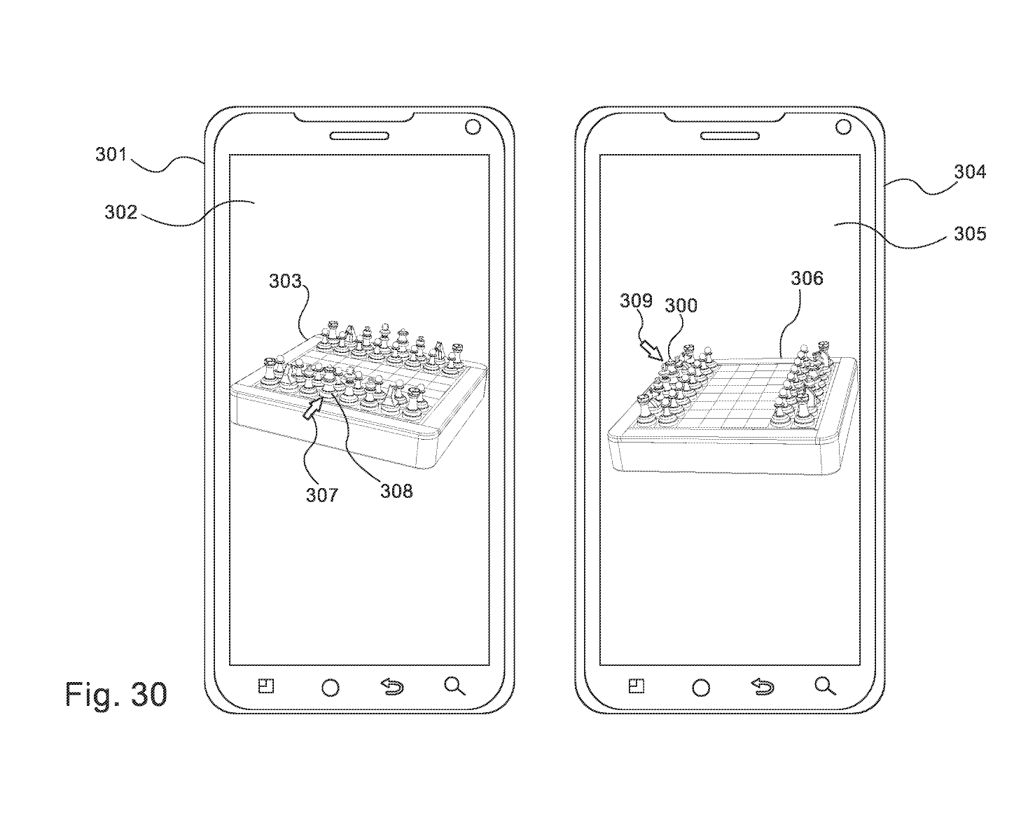

FIG. 30 shows a chessboard (303) displayed on the screen (302) of the teacher's mobile device (301), and the same chessboard (306) displayed in a different angle on the screen (305) of the pupil's mobile device (304). The teacher points with the arrow (307) at the white queen (308), and as a result the arrow (309) displayed on the pupil's mobile device will also point at the white queen (300).

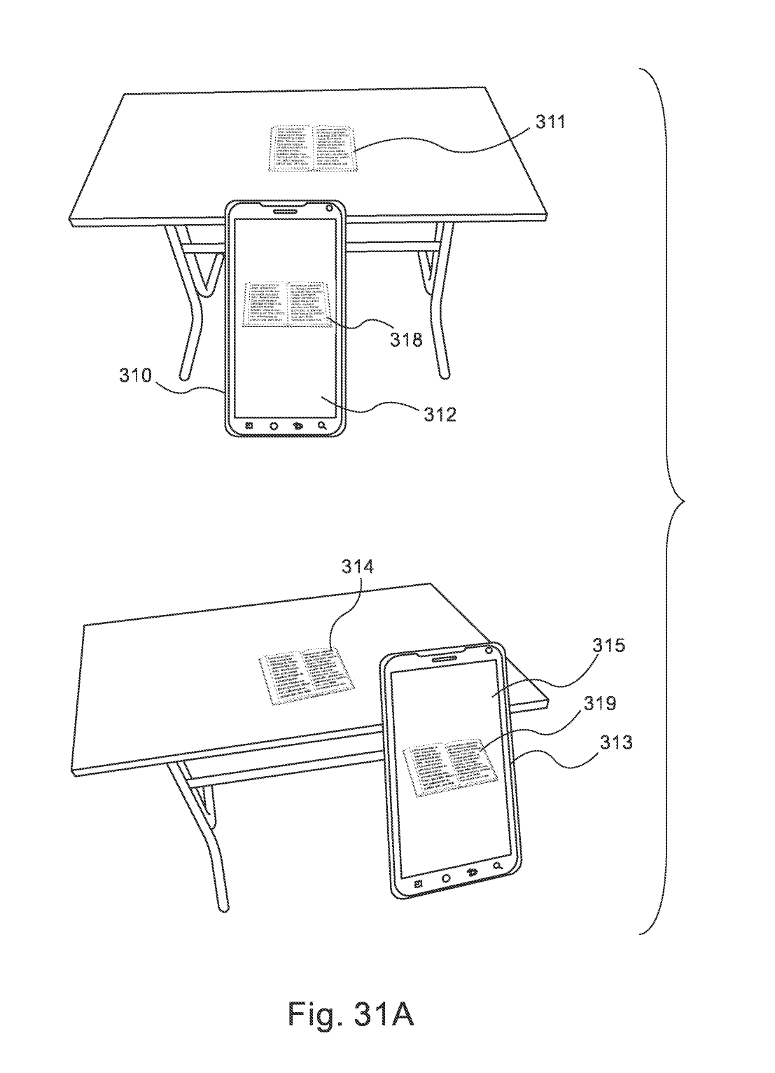

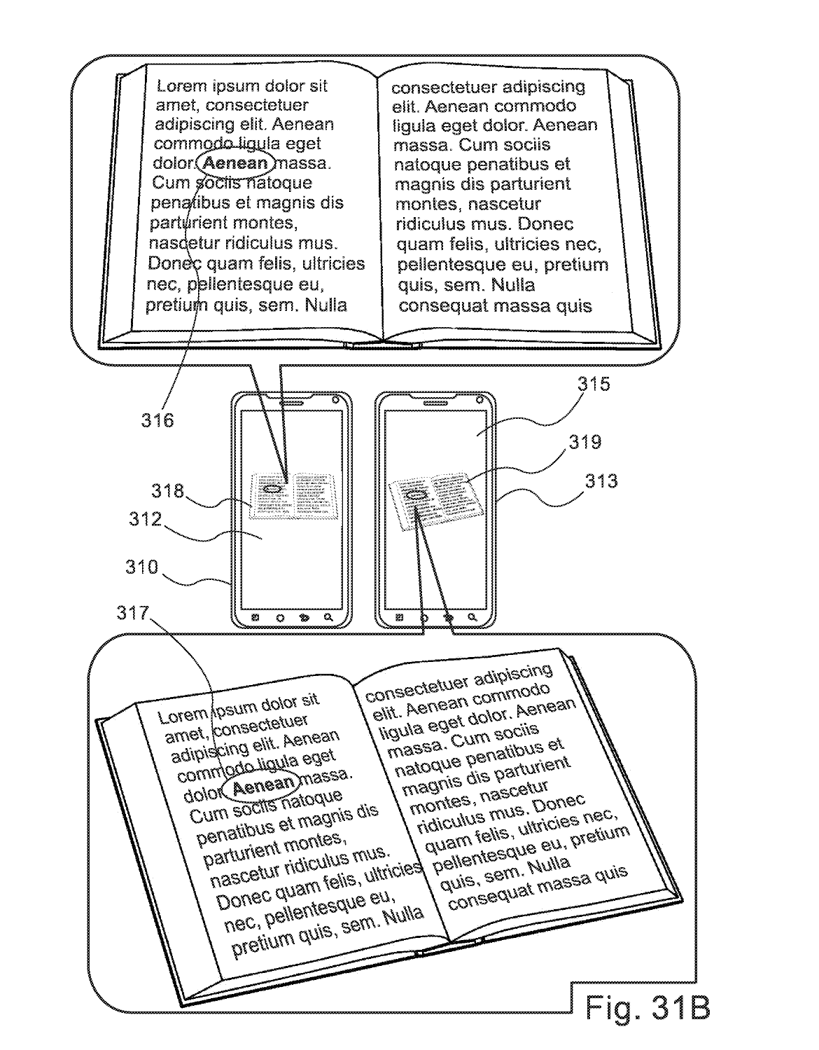

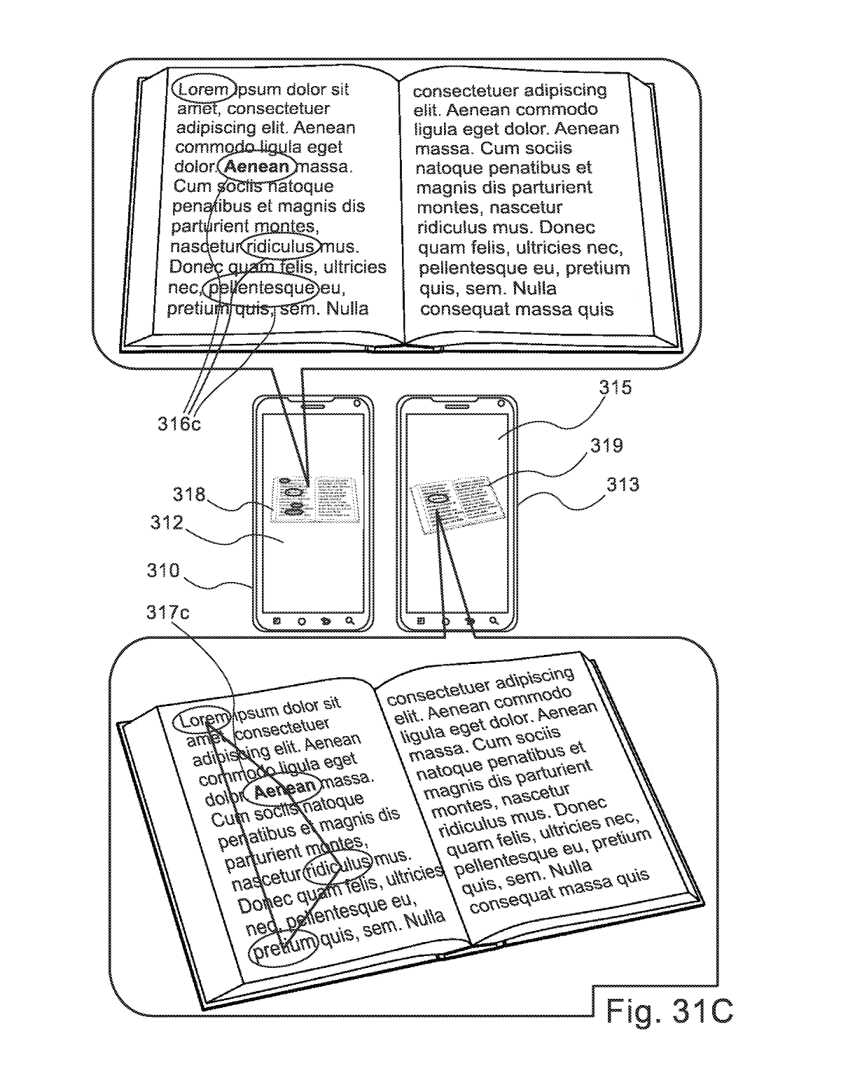

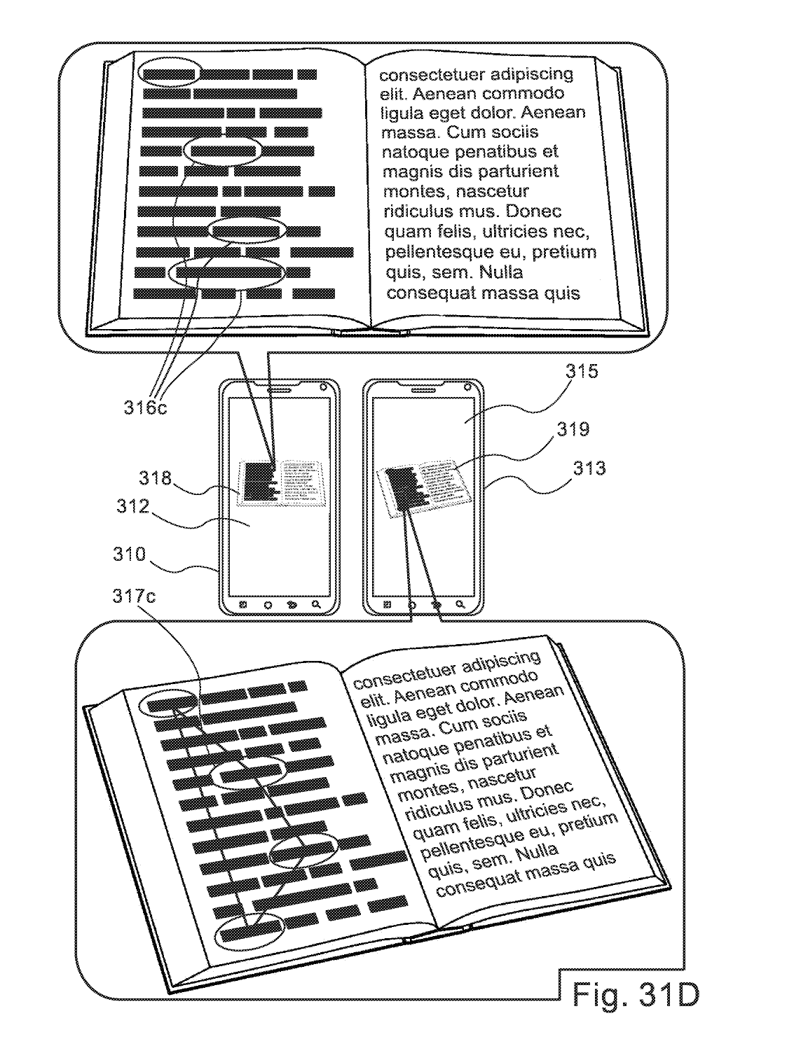

FIGS. 31a-31d show a first mobile device (310) capturing an image of a book (311) and displaying it (318) on the mobile device's screen (312), and a second mobile device (313) capturing an image of a second similar book (314) and displaying it (319) on the second mobile device's screen (315). The teacher marks on the screen of the first mobile device a word (316) in the displayed book, and the same marking (317) appears on the book displayed on the screen of the second mobile device.

FIG. 31c shows an example of using words identification (OCR) to identify a page according to its text and calculate its orientation and distance according to relations between known identified words. The page identification is done according the distribution of the identified words in the page (can be done by adopted dynamic algorithms of “levinstein distance”, replacing words with characters, or similar methodologies). There are many OCR libraries and services. Many OCR tools use dictionaries of known words when they do their matching. In order to make recognition more accurate we can limit the dictionaries that the OCR are using for the dictionary of the specific book we are looking for and as a second stage also to the dictionary of the candidate pages. For the implementation each page should be pre-processed and its words, their order and location are stored. Once viewing the AR module is capturing an image and activating the OCR to extract identified words and their location. based on the words' distribution and location the page can be identified. More than that, each page has a unique relations between the positions of known words. When connecting the center of at least 4 words a rectangle can be defined. The proportions between the known words (for which their relative locations and distances is known for the normalized “top view”) can be used to calculate the device camera orientation and distance toward the page (using algorithms in the family of “Reverse Projective Transform”). This has a significant impact as it enable to track also elements that include only text.

FIG. 31d shows an example of using visual analysis for identification of weather a character is written or not to create a “bar code like” pattern of the page that then being used to identify the page and calculating its orientation and distance from the camera. This is a variation of the method presented in 31c but instead identifying the actual words in the page its identifying the patterns of the written characters, any character. The advantage is that it demand less from the visual computing as it does not require to identify a specific character but just if there is SOME character written or not at this spot. This may enable a faster and better performance when trying to identify text objects in non optimal conditions of orientation, distance and lighting. The identification can use, for example, calculation of “Levenshtein distance” in which the length of the strips replace the characters or other methodologies. The implementation of orientation detection can be done in a similar way to what presented above replacing detected words with a known “stripe” (that extracted based on the identified sequence it is part of). In this case the preprocessing will just have create for each page a matrix that define where there are characters and were not.

According to some embodiments of the present invention, there may be provided a first and second computational device, preferably a mobile computational device which includes a camera, a display, processing circuitry, memory, augmented reality and/or virtual reality software module stored on the memory and executed by the processing circuitry. According to some embodiments the second computational device may be multiple devices. According to some embodiments of the present invention, there may be stored in the memory of the first and second device an image of a 2D or 3D object which may be rendered on the first and second device's screen. The users of the first and second devices may control the angle and/or zoom in which the object is viewed on the screen. According to some other embodiments of the present invention, the cameras of the first and second devices may capture an image of substantially similar objects, each of the devices may capture the object's image from a different angle and/or distance and/or zoom and display the captured object on the device's screen. According to some embodiments of the present invention, the user of the first device may mark or point at or write on or draw on a certain location of the object in the image displayed on his/her device's screen. The augmented reality and/or virtual reality software module may extract the location on the object of the marking or pointing or writing or drawing and transmit the marking or pointing or writing or drawing data, along with their location on the object to the second device(s). The second device(s) may receive the marking or pointing or writing or drawing data, along with their location on the object, and may render on the object displayed on the second device's screen the marking or pointing or writing or drawing according to the received data, at the location received from the first device.

In some learning applications there may be a need for the teacher to write comments on pages of a learning book so that pupils learning from the book will be supplemented by the teacher's comments. The teacher may embed the comments (in the form of text, drawings, pictures, marking, sketching, or any other form) in the book using an editing application, either on a computer or on the web. Once the teacher completed editing the comments, they may be saved on a server which the pupils' mobile devices connect to. When a pupil uses his mobile device to learn from the book, he/she may face the mobile device's camera towards the book so that the book will be displayed on the mobile device's screen, the augmented reality software module may identify the page in the book the pupil is reading and may then access the server to get the comments for that page. Alternatively, the comments for the entire book may be downloaded to the mobile device's memory and when the augmented reality software module identifies the page in the book the pupil is reading, it may retrieve from memory the comments for that page. The augmented reality software module may then detect the places on the displayed page in which comments should be embedded, and render the comments on top of the displayed page in the proper location for each comment.

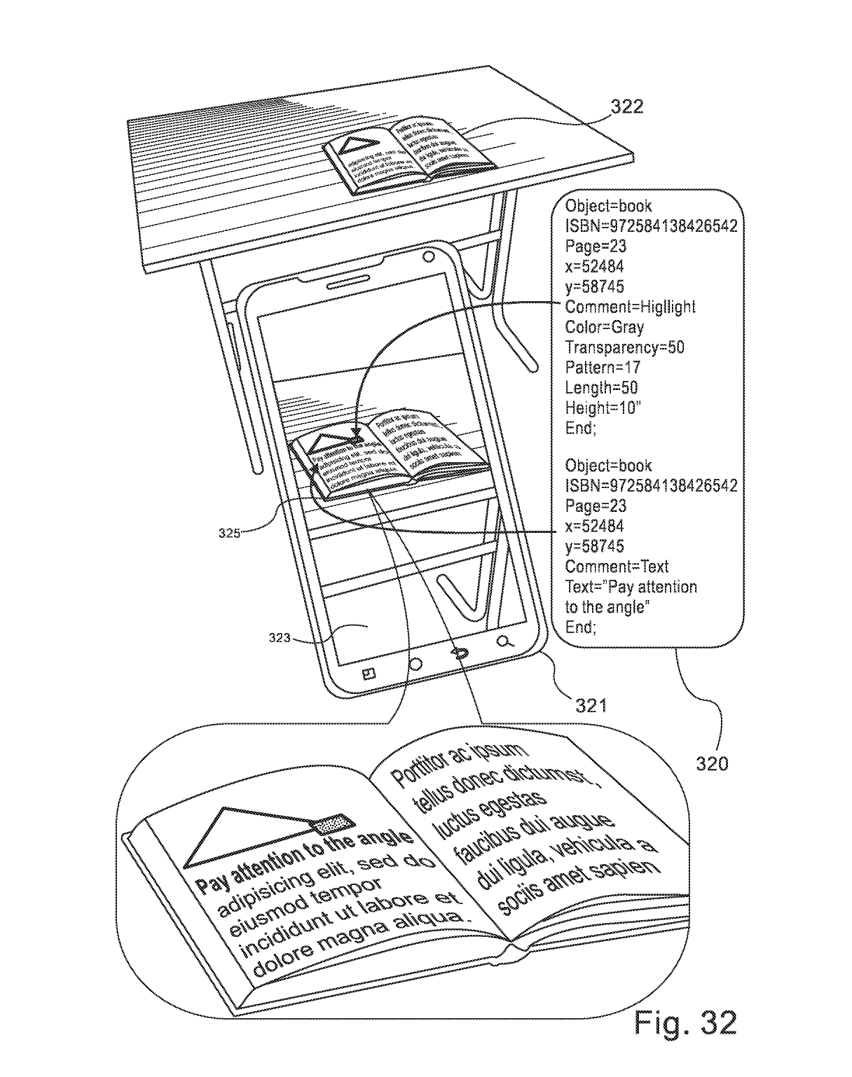

FIG. 32 shows an example of a file (320) created by the teacher using a comments editor. A mobile device (321) captures the image of a book (322) and displays it (325) on the mobile device's screen (323). The comments from file 320 are overlaid (324) on top of the book image (325).

According to some embodiments of the present invention, there may be a book onto which comments are to be added. According to some embodiments the comments may be edited by a user using an editing application (EApp), and may be in the form of text, sketches, drawings, pictures, or any other form that may be displayed on a book's page, the comments may then be saved in a MDL (Metadata and interaction Description Layer) file on a local server or on the cloud. According to some embodiments of the present invention, there may be provided a computational device, preferably a mobile computational device which includes a camera, a display, processing circuitry, memory, augmented reality and/or virtual reality software module stored on the memory and executed by the processing circuitry. According to some embodiments the device may download the MDL file from the server or from the cloud. According to some embodiments the device may be pointed to a book to be read on the device's screen, the device's camera may capture the image of a page in the book, which page may be displayed on the device's screen. According to some embodiments, the augmented reality software module may analyze the captured page to determine what page of the book it is and according to the page number, download the comments layer corresponding to that page from the MDL file stored on the server or cloud, or retrieve the corresponding comments layer from the device's memory if the MDL file was pre-downloaded to the device's memory. The augmented reality software module may then render the retrieved or downloaded comments found in the comments layer, on top of the displayed page of the book in a way that each comment is rendered at its proper location on the page as defined in the MDL file.

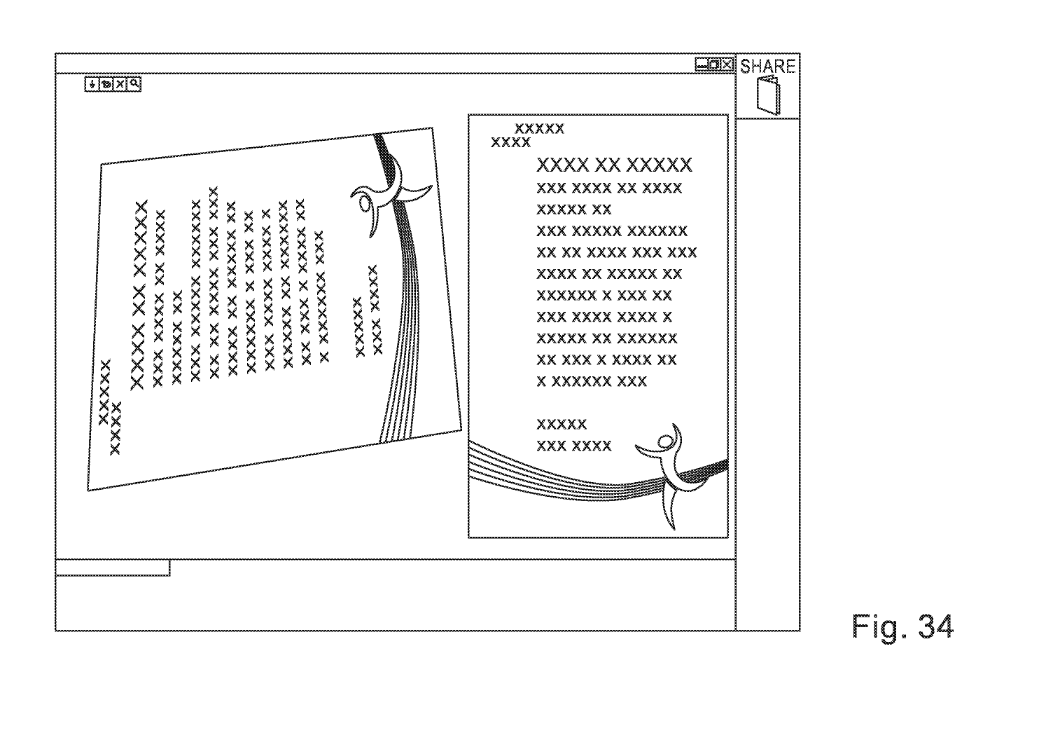

FIG. 34 shows an example of capturing and scanning of an object in real time and normalize it to the defined size and orientation (usually “top view”) even if not presented this way to the camera. It also suggest some indications for the user if he present the object in a way that is too far, steep orientation or if it is moving the page too fast. According to some embodiments of the present invention, a mobile device or desktop device may capture an image of a form or any other type of page using the device's camera. According to these embodiments, the form or page may not need to face the camera directly but may be at some angle relative to the camera and can be in different distances. A scanner software module running on the mobile or desktop device may show in real time the frames around the page and show the actual scanning while adjusting the captured image and transform it to a normalized format in a way that the image of the captured form or page will seem as if it was captured in “front view” and from a defined distance, I.E in a defined size. The normalized format may give the impression that the form or page was scanned by a scanner. According to some embodiments, the “scanning” may take place only when the form or page is within certain distance boundaries, if the form or page is too far the scanning resolution may not be high enough, and if the form or page is too close the camera may not be able to capture the entire sheet. According to some embodiments, the “scanning” may take place only when the form or page is within certain stability boundaries, if the form or page is moving or shaking beyond a certain level the captured image may be blur. According to some embodiments, the “scanning” may take place only when the form or page is within certain orientation boundaries, if the form or page is in a large angle relative to the camera, the resolution may not be high enough and/or the scanner software module may not be able to accurately adjust the captured image to a normalized format. According to some embodiments, the scanner software module may adjust the captured image to a normalized format (“scanning”) by identifying the corners of the form or page and mapping the corner points to the corners of a normalized sheet, all other points in the page or form may be linearly mapped to points in between the corners on the normalized sheet (using algorithms like reverse projection transform). The orientation of a known page or form can be detected by the various methods described in this document (including visual trackers/encores, OCR and “text to barcode” techniques). In case of 3D camera the depth camera can be used to detect the corners of the page (e.g. by cropping the farer background and detecting straight lines by using HFT) and then use (reverse) projections' transformations to extract orientation from the known corners.

According to some embodiments of the present invention, a mobile device or desktop device may store in memory high quality images of forms or pages, for example, forms which may be frequently used. After “scanning” the form or page, the scanner software module may detect that the scanned form or page corresponds to a form or page already stored in the device's memory and may replace the scanned form or page with the higher quality form or page retrieved from memory. According to some embodiments of the present invention, the high quality form or page may be stored in memory along with filled fields in a form (e.g. signature or hand written text) included in the form or page, the scanner software module may use the methods described in this document including identifying as many words as possible in the captured form or page and compare the detected words to words stored in memory in order to match the captured form or page to the proper high quality form or page stored in memory. According to some embodiments, the scanner software module may adjust the captured image to a normalized format by mapping the location of detected captured words to their corresponding location in the page retrieved from memory, all other points in the page or form may be linearly mapped to points in between the detected words on the normalized sheet. According to some other embodiments, the high quality form or page may be stored in memory along with coordinates of spots on the form or page which correspond to characters or words in the form or page. The scanner software module may match the location of the captured spots to the location of the stored spots in order to identify the high quality form or page and detect its orientation.

According to some embodiments of the present invention, a mobile device or desktop device may store in memory high quality images of forms or pages which include manually filled in fields. After “scanning” the form or page which may also be filled in manually, the scanner software module may detect that the scanned form or page, excluding the manually filled in parts, corresponds to a form or page already stored in the device's memory and may replace the scanned form or page with the higher quality form or page retrieved from memory. The scanner software module may then overlay on top of the high quality retrieved form or page, the manually filled in parts from the scanned form or page, in the same locations according to the locations the filled in parts were in, in the scanned page.

According to some embodiments of the present invention, a mobile device or desktop device may store in memory high quality images of forms or pages, along with locations of fields in the form which may be manually filled in. After “scanning” the form or page, the scanner software module may detect that the scanned form or page, excluding the manually filled in fields, corresponds to a form or page already stored in the device's memory and may replace the scanned form or page with the higher quality form or page retrieved from memory. The scanner software module may then overlay on top of the high quality retrieved form or page, the manually filled in fields from the scanned form or page, according to the locations of the fields in the form stored in the device's memory.

According to some embodiments of the present invention, there may be a need to enable scanning of forms and worksheets by the device camera or webcam and also optionally identify which areas should be filled in handwriting, checkboxes and other types of written input on a page, form or worksheet a user filled in or checked (for example, in a multiple choice test). According to these embodiments, there may be a page with checkboxes to be checked by a user, and a corresponding file (MDL file) which includes the locations of the checkboxes within the page. The MDL file may be stored in the device's memory. According to some embodiments, the device's camera may capture an image of the page the user may have marked and a software module running on the device's processing unit may analyze which field has been filled (and indicate accordingly) and which checkboxes were checked and which ones weren't. According to some embodiments, the analysis if a field was filled in or not may be done by checking the brightness of the internal area of a tested checkbox and comparing that brightness to the brightness of the internal area of other checkboxes in proximity to the tested checkbox, if the brightness of the internal area of the tested checkbox is closer to the brightness of the internal area of brighter checkboxes in its proximity, then that checkbox is considered to be unchecked, if the brightness of the internal area of the tested checkbox is closer to the brightness of the internal area of the darker checkboxes in its proximity, then that checkbox is considered to be checked. A similar process may be done to identify if a field has been filled by comparing its brightness to the brightness of other areas which are known to be blank and that should be of the same characteristics as of an empty field. According to some embodiments, the pixels in the internal area of the tested checkbox may be examined to determine whether there is a large difference between the pixels' grayscale values, if a large difference is found in more than a predefined number of pixels, than the checkbox is considered to be checked, otherwise it is considered to be unchecked. A large difference in the pixels' brightness may be defined as a difference in brightness in the range of the difference between the brightest pixel in the internal area of the tested checkbox, and a pixel on the border of the tested checkbox. Other definitions/algorithms for “large difference” may be as good. According to some embodiments of the present invention, the software module may determine the location of the checkboxes on the page from information in the page's MDL file stored in the device's memory.

In applications where an anchor is being used and in which the augmented reality and/or virtual reality software module may need to constantly determine the anchor's location in order to display on the device's screen an augmented reality object based on the anchor's location, there may be a need to constantly identify the anchor despite environmental conditions which may disturb proper identification of the anchor. The disturbances may be caused by a human's unsteady hand holding the mobile device which may result in the captured anchor to seem shaking, changes in lighting conditions, light flickering, low light intensity, and more. In order to assist identifying the anchor's location by the visual analysis of the captured image, multiple sensors and techniques may be used to gain more data on the anchor's location. For instance, if the visual analysis determines that the anchor's image is shaking, but the input from the accelerometer shows that the device is relatively steady, then the detected anchor's position will be reported to remain steady. Another case may be flickering of the light, this may be as a result of objects moving near the anchor and/or mobile device which are causing shadows on the anchor, or a tree outside the window shaking in the wind, or any other cause that may result in an unstable lighting. The light flickering may cause the visual analysis software to not be able to identify the anchor at all times, in order to solve that, a low-pass filter may be implemented so that the visual analysis software will see ‘slow’ lighting changes which it may be able to deal with rather than disturbing high frequency light intensity changes. In other cases, in which the detection of the anchor may be sporadic due to disturbances, the gyro may be used to keep track of the anchor's location based on the mobile device's movement, the anchor's location may be determined by the visual analysis software in times when there is a visual anchor detection and the gyro may keep track of the estimated location during the times in which the visual analysis fails to detect the anchor. In other cases in which the visual analysis looses track of the anchor due to poor lighting, the sensitivity of the image sensor may be increased in order to enhance the image quality in the estimated location of the anchor, and the focus may be adjusted to focus on the estimated location of the anchor. In extreme bad lighting conditions, the device's LED may be turned on to light the anchor, or in cases in which a mobile device's front camera or a webcam is being used, the mobile device or desktop screen may be set to be very bright to light the anchor.

According to some embodiments of the present invention, there may be a need for the augmented reality software module on the mobile device to keep track of an object which may serve as an anchor. According to some embodiments, tracking the anchor may be done by fusion of multiple inputs analyzed by, and several elements of the mobile device controlled by, a tracking software module associated with the augmented reality software module and executed by the processing circuitry of the mobile device to continuously estimate the 3D coordinates and orientation of the anchor. According to some embodiments of the present invention, the tracking software module may receive as input a captured image from the mobile device's camera and/or data from the mobile device's gyro and/or accelerometer and/or compass, and may control the camera's focus and/or image sensor sensitivity and/or the LED. The tracking software module may apply different filtering and fusing techniques on the input data and/or image and integrate the data received from the multiple sources in order to continuously and reliably track better and in a more stable way the anchor even at harsh viewing conditions. According to some embodiments, the tracking software module may receive a captured image from the mobile device's camera and may perform visual analysis to detect the anchor's location within the image. The visual analysis may keep track of any movement of the anchor. Upon detection of unstable lighting conditions such as light flickering that may destruct the anchor detection, the visual analysis may apply a low-pass or other filters on the captured image to reduce flickering effect. Upon detection of insufficient light which prevents or makes the anchor detection very difficult, the tracking software module may increase the image sensor sensitivity until the image at the area substantially close to the anchor, or to the estimated location of the anchor, is proper. If the light intensity is low, the tracking software module may turn on the LED to light the tracked object. If the visual analysis is not so successful in detecting the anchor due to the image not being in focus in the anchor's area, the tracking software module may adjust the camera's focus to have the anchor in focus. If the visual analysis looses track of the anchor, the tracking software module may still keep track of the estimated location of the anchor by calculating, since the anchor was last detected by the visual analysis, the mobile device movement using the gyro and accelerometer until the visual analysis gains track again. According to some embodiments of the present invention, if the tracking software module receives information from the visual analysis that the anchor's image is shaking, it may check the data received from the gyro and/or accelerometer, and fuse it together with the visual computing data as per anchor location, thus, if for example the received data indicates that the mobile device is substantially close to being stable it may refer to the anchor as being stable. In this case the anchor's location may be determined as the average location of the shaking image of the anchor, or use other techniques like “samples majority votes” for extracting out few fluctuations to further stabilize it.

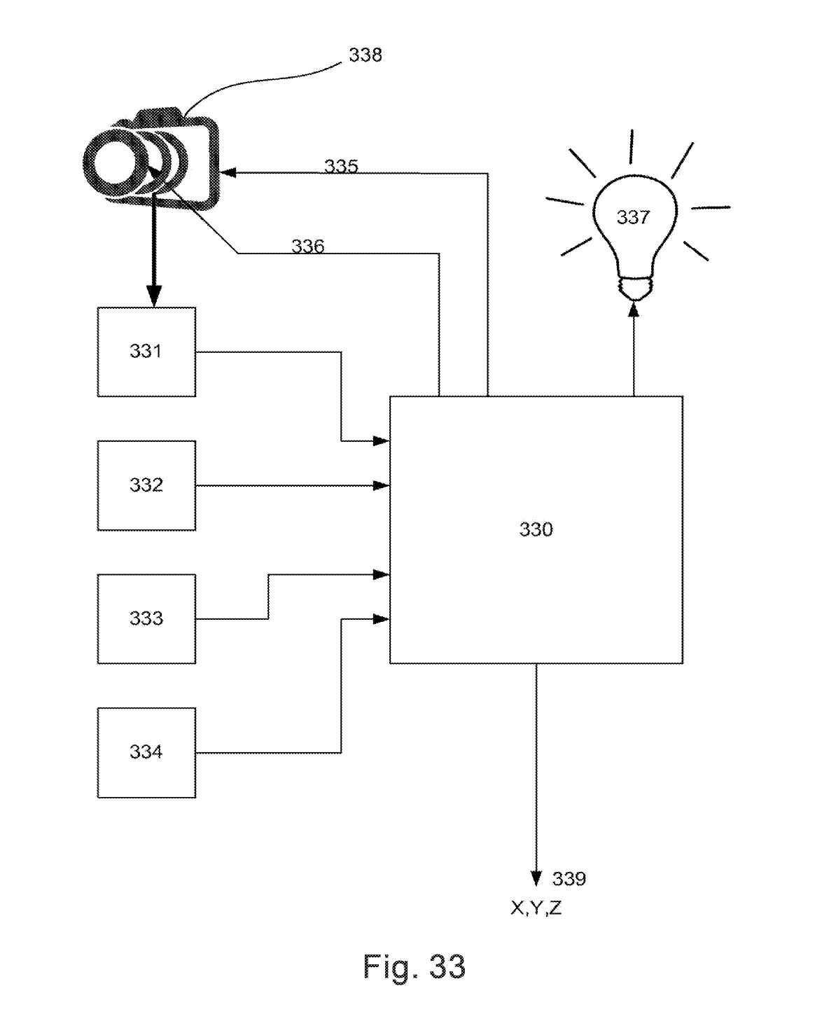

FIG. 33 shows an example of an anchor tracking arrangement. The tracking software module (330) receives inputs from the Visual Analysis module (331), the gyro (332), the accelerometer (333), and the compass (334). The tracking software module controls the camera's image sensor (335) sensitivity, the camera's focus (336), and the mobile device's LED (337). The outputs (339) of the tracking software module are 3D coordinates and orientation of the anchor in a 3D “world”. The Visual Analysis module receives captured images from the camera (338).

Upon the tracking software module determining or estimating the anchor's location, it may output 3D coordinates and orientation of the anchor. Do to vibrations, calculation effects, unstable lighting, etc., the tracking software module may output an unsteady location of the anchor. Therefore, there may be a need in some modes of operation to stabilize the anchor.

According to some embodiments of the present invention, the determined or estimated 3D coordinates and orientation of the anchor by the tracking software module may be unstable. According to some embodiments, there may be an optional stabilizing module which may receive the 3D coordinates and orientation of the anchor, and also optionally the gyro and/or accelerometer and/or focus data as input, and calculate a stabilized 3D coordinates and orientation of the anchor as output. According to some embodiments, the stabilized location of the anchor may be calculated by performing some processing (like “majority vote” and others) on the location determined or estimated by the tracking software module.

In some augmented reality cases in which an anchor is being used for rendering an image stored in the mobile device's memory as an overlay on top of a captured background, and in which the tracking of the anchor suddenly fails (for example, due to bad lighting conditions), there may still be a need to keep displaying the image stored in the mobile device's memory as an overlay on top of a captured background in a way that tracks the mobile device's movement. In order to achieve this, upon tracking failure the captured background's image may be saved in the mobile device's memory, and the virtual reality software module may render the saved background image on the mobile device's screen and the stored image may be rendered on top of the background image. Any movement of the mobile device may be detected by the gyro and/or accelerometer and may cause rendering the background image and the stored image as if seen from the new location of the mobile device. According to some embodiments of the present invention, there may be provided a computational device, preferably a mobile computational device which includes a camera, a display, a gyro and/or accelerometer, processing circuitry, memory, augmented reality and/or virtual reality software module stored on the memory and executed by the processing circuitry. According to some embodiments of the present invention, a user may hold the mobile device such that the mobile device's camera may capture the image of the background behind the mobile device on which an anchor object is placed. According to some embodiments of the present invention, the augmented reality software module may display on the mobile device's screen the image which the camera captures, and render an image stored in the mobile device's memory layered on top of the image captured by the camera and according to the anchor's location and orientation, in a way that the stored image may seem, to a user watching the mobile device's screen, to be physically located behind the mobile device on top of the background. According to some embodiments a tracking software module associated with the augmented reality and/or virtual reality software module may track the anchor as the mobile device moves, and the augmented reality software module may render the stored image on top of the captured image according to the tracked anchor's location and orientation. According to some embodiments, if the tracking software module losses track of the anchor, the virtual reality software module may save the image of the captured background in the mobile device's memory, and keep track of an estimated location and orientation of the anchor from inputs received from the gyro and/or accelerometer. The virtual reality software module may render the background stored in the mobile device's memory, and the overlay image stored in the mobile device memory according to the estimated anchor location and orientation. According to some embodiments, once the tracking software module regains track of the anchor, the captured background can again be displayed on the screen instead of the saved background image.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A presentation device comprising:
a digital camera assembly including an imaging sensor, one or more optical elements, and image data generation circuits adapted to convert image information acquired from a surrounding of said device into one or more digital image frames indicative of the acquired image information;
one or more activity sensors to detect activity on or near said device;
a graphical display assembly including at least one display and driving circuits adapted to receive display instructions and to convert received display instructions into electrical signals which regulate illumination or appearance of one or more display elements; and
processing circuitry, including image processing circuitry, to generate a set of display instructions for displaying a display image which display image is at least partially based on information with a digital image frame indicative of an acquired image and one or more processing circuit rendered virtual objects, wherein selection of which virtual objects to render and how to position the virtual objects within the display image is at least partially based on a context state of said device, such that a context state defines spatial associations between virtual objects and objects within the digital image frame, and wherein the context state of said device is set substantially automatically in response to conditions or activity detected through said activity sensors or through said imaging sensor.

2. The device according to claim 1, wherein a given context mode is triggered upon detection of any one or combination of: (1) one or more given objects in a digital image frame, (2) one or more given motions or gestures made with said device, (3) actuation of one or more user inputs, (4) one or more given sounds or sequence of sounds, (5) one or more given external electrical signals generated by an external device, (6) proximity of said device to a specific location, and (7) one or more persons located in proximity to said device.

3. The device according to claim 1, wherein said processing circuitry is further adapted to operate in operational modes including: (a) a first operational mode in which virtual objects are overlayed on to digital image frames indicative of acquired image information; and (b) a second operational mode in which acquired image information is used to generate or affect virtual elements of a virtual environment.

4. The device according to claim 3, wherein the transition from the first operational mode to the second operational mode occurs incrementally, such that an physical object appearing within acquired image frame is augmented with virtual markings within the generated display image and the physical object is also represented by a virtual representation within the generated display image.

5. The device according to claim 1, wherein rendered virtual objects are encoded in real time from two different point of views, one for each eye of an user, in correspondence to selected 3D glasses and to achieve a 3D effect.

6. The device according to claim 1, wherein one or more activity sensors are sensor adapted to identify a position of a user's head, and the image processing circuits are further adapted to adjust the display image on the display in accordance with a location in space of the head.

7. The device according to claim 1, wherein a rendered virtual object is a virtual equivalent or representation of an object detected in the digital image frame and the virtual object replaces either augments, overlays or replaces the detected object within the display image.

8. The device according to claim 7, wherein the object detected in the digital image frame is a tillable form including both form text and tillable fields

9. The device according to claim 8, wherein the display image includes both: (a) a virtual equivalent of the detected form, and (b) digital image frame portions indicative of image information acquired from tillable field areas of the detected form.

10. The device according to claim 9, wherein display image and elements contained therein are normalized based on anchor visual elements on the detected form or visual analysis and identification of the page in the space that may use a 3D camera.

11. The device according to claim 9, wherein a presence or absence of text in a tillable field of the detected form are assessed.

12. The device according to claim 11, wherein optical character recognition is performed on digital image frame portions indicative of image information acquired from tillable field areas of the detected form.

13. The device according to claim 1, wherein a position and/or orientation of a display image representing a point of view within an at least partially virtual environment is at least partially based on image information acquired by the image sensor of the surroundings.

14. The device according to claim 1, wherein said device is in the form-factor of headgear and the graphical display assembly includes two separate displays, one for each eye of a user.

15. The device according to claim 14, wherein at least one digital camera assembly is a forward looking camera assembly which enables the device to: (1) identify its location and point of view within a space; and (2) to generate user indicators corresponding to their location relative to the space and objects within the space.

16. The device according to claim 1, wherein at least one virtual object or element within the display picture is generated responsive to an external signal indicating an object or position in space designated by a user of another device.

17. The device according to claim 1, wherein a signal from optical focusing circuits of said digital camera assembly are used to estimate a distance to a point on an acquired image.

18. The device according to claim 1, wherein results of an optical character recognition process are used to identify an object and estimate its distance and orientation relative to the device.

19. The device according to claim 1, wherein results of a visual analysis that identify where characters are written or absent from an object are used to identify the object and to estimate a distance and orientation of that object relative to the device.

20. The device according to claim 1, wherein at least one virtual object or element within the display image is generated to direct a user to a specific object or location in space.

21. The device according to claim 1, further comprising activating lighting compensation circuits selected from: (1) circuits which drive an illuminator of said device; and (2) circuits which drive the display of said device.

22. The device according to claim 1, further comprising stabilizers for visual tracking, wherein the stabilizers are in the form of filters functionally associated with one or more sensors selected from the group consisting of: (1) a accelerometer, and (2) a gyro.

23. The device according to claim 1, wherein said digital camera assembly is a 3D camera assembly and said image processing circuitry is adapted to use depth information from acquired image frames to normalize a display image of an object within the acquired image frame.

24. The device according to claim 23, wherein said device is adapted to image and display normalized images of forms or pages.
